(19) United States
(12) Patent Application Publication
(10) Pub. No.: US 2025/0363331 A1
(43) Pub. Date: Nov. 27, 2025

(54) SYSTEM AND METHOD FOR ENHANCED FUTURE PREDICTION USING RESERVOIR TRANSFORMER

(71) Applicant: YONUX LLC, Baltimore, MD (US)

(72) Inventor: Jia XU, Hoboken, NJ (US)

(73) Assignee: YONUX LLC, Baltimore, MD (US)

(21) Appl. No.: 19/215,833

(22) Filed: May 22, 2025

Related U.S. Application Data
(60) Provisional application No. 63/651,356, filed on May 23, 2024.
(60) Provisional application No. 63/651,365, filed on May 23, 2024.

(51) Int. Cl. G06N 3/045; G06N 3/08

(52) U.S. Cl. CPC G06N 3/045; G06N 3/08

(57) ABSTRACT

Provided are system, method, and device for automatically enhancing future prediction using a reservoir transformer in a machine learning model. According to example embodiments, the system may include: a memory storage storing computer-executable instructions; and at least one processor communicatively coupled to the memory storage, wherein the at least one processor may be configured to execute the instructions to: obtain current input data representing a current state of a complex system; determine a plurality of readout data based on previous input data representing a previous state of the complex system using a plurality of reservoirs; combine the plurality of readout data to form an ensemble reservoir data; and determine predicted output data representing a predicted state of the complex system based on the ensemble reservoir data and the current input data using a transformer.

This application claims priority from U.S. Provisional Patent Application No. 63/651,365, filed with the United States Patent and Trademark Office on May 23, 2024 and entitled “INFINITE TRANSFORMER BY RESERVOIR COMPUTING”, and U.S. Provisional Patent Application No. 63/651,356, filed with the United States Patent and Trademark Office on May 23, 2024 and entitled “CHANGES BY BUTTERFLIES: FARSIGHTED FORECASTING WITH GROUP RESERVOIR TRANSFORMER”, the disclosure of which are incorporated herein by reference in their entirety.

### TECHNICAL FIELD

Example embodiments of the present disclosure relate to a reservoir transformer in a machine learning model, and more specifically, relate to the enhancement of future prediction using a reservoir transformer in a machine learning model.

### BACKGROUND

Time-series forecasting (TSF) and long term time-series forecasting (LTSF) refer to processes of predicting and forecasting future trends of a complex system based on historical data.

The complex system may refer to systems comprising a large number of interdependent variables, where the actions and behaviors of the variables together shape the behavior of the complex system as a whole. Examples of the complex system may include weather, stock market trend, human speech, and the like.

In this regard, the LTSF may differ from the TSF in that the LTSF enables analysis with longer length of forecasting horizon as well as higher complexity of the pattern underlying the behavior of the complex system than the general TSF. This property is helpful in analyzing and predicting future trends of a complex system, since many complex systems require extensive knowledge and information on pattern underlying their behaviors in order to fully understand and predict their future trends. For example, human speech requires an extensive knowledge in culture, context, sentence structure, and the like in order to fully understand the meaning behind a sentence.

### SUMMARY

Example embodiments consistent with the present disclosure enable prediction of future trend of a complex system with machine learning, while addressing challenges related to the sensitivity of initial conditions and the input length limitation.

According to example embodiments, a system is provided. The system may include: a memory storage storing computer-executable instructions; and at least one processor communicatively coupled to the memory storage, wherein the at least one processor may be configured to execute the instructions to: obtain current input data representing a current state of a complex system; determine a plurality of readout data based on previous input data representing a previous state of the complex system using a plurality of reservoirs; combine the plurality of readout data to form an ensemble reservoir data; and determine predicted output data representing a predicted state of the complex system based on the ensemble reservoir data and the current input data using a transformer.

According to example embodiments, the complex system may include one or more of: traffic, weather, exchange rate, electricity, air quality, electricity transformer temperature (ETT), and in-line inspection (ILI), wherein the current state of the complex system may represent a state of the complex system at a current time, and wherein the predicted state of the complex system may represent a prediction of a state of the complex system at a time after the current time.

According to example embodiments, the previous state of the complex system may represent all states of the complex system from an initial time to a time before the current time.

According to example embodiments, the plurality of readout data may include a plurality of non-linear readout data, and wherein the plurality of non-linear readout data may be determined based on the previous input data in combination with a self-attention mechanism using the plurality of reservoirs.

According to example embodiments, the plurality of readout data may include a plurality of linear readout data, and wherein the predicted output data may be determined based on the ensemble reservoir data and the current input data using the transformer and a cross-attention mechanism.

According to example embodiments, the plurality of reservoirs may include echo state network (ESN) reservoirs.

According to example embodiments, the at least one processor may be further configured to train the transformer using a loss function.

According to example embodiments, a method is provided. The method may include: obtaining current input data representing a current state of a complex system; determining a plurality of readout data based on previous input data representing a previous state of the complex system using a plurality of reservoirs; combining the plurality of readout data to form an ensemble reservoir data; and determining predicted output data representing a predicted state of the complex system based on the ensemble reservoir data and the current input data using a transformer.

According to example embodiments, the complex system may include one or more of: traffic, weather, exchange rate, electricity, air quality, electricity transformer temperature (ETT), and in-line inspection (ILI), wherein the current state of the complex system may represent a state of the complex system at a current time, and wherein the predicted state of the complex system may represent a prediction of a state of the complex system at a time after the current time.

According to example embodiments, the previous state of the complex system may represent all states of the complex system from an initial time to a time before the current time.

According to example embodiments, the plurality of readout data may include a plurality of non-linear readout data, and wherein the plurality of non-linear readout data may be determined based on the previous input data in combination with a self-attention mechanism using the plurality of reservoirs.

According to example embodiments, the plurality of readout data may include a plurality of linear readout data, and wherein the predicted output data may be determined based on the ensemble reservoir data and the current input data using the transformer and a cross-attention mechanism.

According to example embodiments, the plurality of reservoirs may include echo state network (ESN) reservoirs.

According to example embodiments, the method may further include training the transformer using a loss function.

According to example embodiments, a non-transitory computer-readable recording medium is provided. The non-transitory computer-readable recording medium may have recorded thereon instructions executable by at least one processor to cause the at least one processor to perform a method including: obtaining current input data representing a current state of a complex system; determining a plurality of readout data based on previous input data representing a previous state of the complex system using a plurality of reservoirs; combining the plurality of readout data to form an ensemble reservoir data; and determining predicted output data representing a predicted state of the complex system based on the ensemble reservoir data and the current input data using a transformer.

According to example embodiments, the complex system may include one or more of: traffic, weather, exchange rate, electricity, air quality, electricity transformer temperature (ETT), and in-line inspection (ILI), wherein the current state of the complex system may represent a state of the complex system at a current time, wherein the predicted state of the complex system may represent a prediction of a state of the complex system at a time after the current time, and wherein the previous state of the complex system may represent all states of the complex system from an initial time to a time before the current time.

According to example embodiments, the plurality of readout data may include a plurality of non-linear readout data, and wherein the plurality of non-linear readout data may be determined based on the previous input data in combination with a self-attention mechanism using the plurality of reservoirs.

According to example embodiments, the plurality of readout data may include a plurality of linear readout data, and wherein the predicted output data may be determined based on the ensemble reservoir data and the current input data using the transformer and a cross-attention mechanism.

According to example embodiments, the plurality of reservoirs may include echo state network (ESN) reservoirs.

According to example embodiments.

Additional aspects will be set forth in part in the description that follows and, in part, will be apparent from the description, or may be realized by practice of the presented embodiments of the disclosure.

### BRIEF DESCRIPTION OF THE DRAWINGS

Features, aspects, and advantages of embodiments of the disclosure will be described below with reference to the accompanying drawings, in which like reference numerals denote like elements, and wherein:

FIG. 1 illustrates a flow diagram of an example method for enhancing future prediction using a reservoir transformer, according to one or more example embodiments;

FIG. 2 illustrates a block diagram of a visual representation of a process to obtain an ensemble reservoir data, according to one or more example embodiments;

FIG. 3 illustrates a block diagram of a visual representation of a process to obtain a predicted output data, according to one or more example embodiments;

FIG. 4 illustrates a block diagram of a visual representation of a general abstract structure corresponding to the process to obtain the predicted output data, according to one or more example embodiments;

FIG. 5 illustrates a block diagram of a visual representation of a reservoir deep neural networks, according to one or more example embodiments;

FIG. 6 illustrates an example flow of data involving scalar value embedding and embedding restoration decoding, according to one or more example embodiments;

FIG. 7A to FIG. 7B illustrate algorithms for training the transformer, according to one or more example embodiments;

FIG. 8 illustrates a comparison of multivariate long-term forecasting errors using the Mean Squared Error (MSE) metric;

FIG. 9 illustrates a comparison of Time Series Lengths and Correlation Dimensions (D₂) for Mackey Glass Series (MGS), Electrocardiogram Signal (ECG), and Lorenz Attractor datasets;

FIG. 10 illustrates a comparison of NLinear and reservoir transformer for explaining the Lyapunov Exponent's predictive performance across different datasets;

FIG. 11 illustrates a visualization comparing the prediction of the Lyapunov Exponent using NLinear and reservoir transformer;

FIG. 12 illustrates entropy in different datasets;

FIG. 13 illustrates a relationship between the number of the ensemble reservoirs and system performance;

FIG. 14A to FIG. 14D illustrate a LIME explanation effect of current input (A) and reservoir (B) on output prediction;

FIG. 15 illustrates performance assessment table on both training and datasets;

FIG. 16 illustrates a relationship between parameter size and mean absolute error MAE;

FIG. 17 illustrates a table showing multi-variate time series datasets for regression;

FIG. 18A illustrates a relationship between the highest price and time sequence for gold price time sequence detection;

FIG. 18B illustrates a relationship between the highest price and time sequence for daily order time sequence detection;

FIG. 19 illustrates a table showing multi-variate time series datasets for classification;

FIG. 20 illustrates a time-series forecasting prediction error rate results;

FIG. 21 illustrates time series comparison in MSE, MAE, Accuracy, and F-score with reservoir transformer and baseline transformer;

FIG. 22 illustrates MSE on three typical datasets;

FIG. 23 illustrates MSE versus horizon length;

FIG. 24 illustrates a relationship between the number reservoirs in the ensemble reservoir and system performance;

FIG. 25A to FIG. 25B illustrate the effect of Leaky values and reservoir size on the reservoir transformer model;

FIG. 26 illustrates the memory (cache) footprint and time complexity of different models;

FIG. 27 illustrates a comparison of the memory usage and training time of the reservoir transformer method with other approaches;

FIG. 28 illustrates a list of reservoir settings for all 10 different reservoirs;

FIG. 29 illustrates an Echo Transformer architecture, according to one or more example embodiments;

FIG. 30 illustrates a comparison between the Echo Transformer architecture of the example embodiments of the present disclosure with other popular models;

FIG. 31 illustrates various configurations for different ESN;

FIG. 32 illustrates a comparison of accuracy between the Echo Transformer architecture and several baseline models;

FIG. 33 illustrates leaky value effect on model performance;

FIG. 34 illustrates activation function effect on model performance;

FIG. 35 illustrates reservoir effect on model performance; and

FIG. 36 illustrates a block diagram of example components in a system, according to one or more example embodiments.

### DETAILED DESCRIPTION

The following detailed description of exemplary embodiments refers to the accompanying drawings. The foregoing disclosure provides illustration and description but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “[A] and/or [B]”, “at least one of [A] and [B]” or “at least one of [A] or [B]” are to be understood as including only A, only B, or both A and B.

Expressions such as “at least one processor,” where configured to implement a plurality of operations, execute a plurality of instructions, etc., are to be understood as a single processor implementing the plurality of operations, etc., or each of plural processors implementing at least some (but not necessarily all) of the plurality of operations, etc.

Reference throughout this specification to “one embodiment,” “an embodiment,” “non-limiting exemplary embodiment,” or similar language means that a particular feature, structure, or characteristic described in connection with the indicated embodiment is included in at least one embodiment of the present solution. Thus, the phrases “in one embodiment”, “in an embodiment,” “in one non-limiting exemplary embodiment,” and similar language throughout this specification may, but do not necessarily, all refer to the same embodiment.

Further, the described features, advantages, and characteristics of the present disclosure may be combined in any suitable manner in one or more example embodiments. One skilled in the relevant art will recognize, in light of the description herein, that the present disclosure can be practiced without one or more of the specific features or advantages of a particular embodiment. In other instances, additional features and advantages may be recognized in certain embodiments that may not be present in all embodiments of the present disclosure.

As described above, the LTSF enables analysis of complex systems with longer length of forecasting horizon as well as higher complexity of the pattern underlying the behavior of the complex systems.

In this regard, the accuracy and performance of the LTSF as well as TSF depend on the time span of past events used for learning and training. Modelling long-term dependencies is crucial as the effects of enduring events unfold over time.

In particular, certain complex system may exhibit behavior described by chaos theory. Chaos theory describes a theory underlying patterns and deterministic laws that govern dynamical systems. The chaos theory describes a concept known as “sensitivity to initial conditions” (also known as “the butterfly effect”), where systems with many coupled variables, such as tornados, human brain activities, stock markets, and the like, often exhibit chaotic behavior that is affected by their initial conditions.

In particular, when two different initial conditions exhibit only a minor disparity, such minor disparity will diverge and undergo exponential amplification over time, such that two systems with only small different initial conditions will over time diverge into two vastly different systems.

Chaos theory has found broad applications spanning various disciplines within human society, such as biology, chemistry, physics, economics, mathematics, and the like, with the purpose of predicting and forecasting futures through the use of artificial intelligence and machine learning techniques.

Chaos theory has been utilized and applied in machine learning to predict and forecast futures of complex systems, such as fluid flow, weather, climate, stock market, and the like, where past incidents can indicate future events.

In this regard, the application of LTSF to predict and forecast future trends of such complex system faces two primary challenges.

Firstly, the prediction of future trends of a complex system suffers from a concept known as Lyapunov time which is inherent in all complex systems. In particular, Lyapunov time describes a rate of separation of infinitesimally close trajectories, or in other words, a rate at which two initial conditions diverge from each other in a complex system.

Here, the Lyapunov time has been utilized to determine an amount of time in which a complex system can be effectively predicted (a limit of prediction), where initial conditions can be used to predict the future up until a certain point, after which the divergence from the initial condition becomes so great that future cannot be predicted based on such initial conditions. Conventionally, it is believed that prediction can only be made within two or three times the Lyapunov time.

Secondly, the prediction of future trends of a complex system may utilize transformers to convert input sequences (e.g., initial conditions) to output sequences (e.g., future events) for both training and inference. However, such transformers are limited in input length, which limits the potential and effectiveness of the transformer to predict accurate outputs.

More specifically, transformers have intrinsic constraints which manifests in their quadratic time and memory complexity related to input length. Conventional transformers, such as Bidirectional Encoder Representations from Transformers (BERT) has a restriction of 512 input tokens, while generative pre-trained transformer two (GPT-2) has a restriction of 1024 input tokens. Such inherit limitation imposes significant hindrance when performing long-term forecasting/predicting tasks, since long sequential inputs may be useful in understanding different contexts. For example, in language learning, different words may have different meanings depending on the context. Lack of effective contextual understanding can lead to incoherent or irrelevant responses in longer conversations, restricting the model's capacity to engage in sustained and coherent dialogue.

In this regard, solutions have been proposed in the related art to address the limitation of input length in transformers. For example, solutions such as efficient transformer, reformer, and the like have been proposed to extend the limit of the input length. Nevertheless, ultimately, the above solutions merely extend the limit of the input length to another fixed value, which still limits the adaptability for learning from and predicting arbitrary long sequences.

In view of the above, there is a need for a solution to enable prediction of future trends of a complex system with machine learning, while addressing the above challenges related to the sensitivity of initial conditions and the input length limitation in order to improve performance for LTSF and TSF.

It is contemplated that features, advantages, and significances of example embodiments described herein are merely a portion of the present disclosure, and are not intended to be exhaustive or to limit the scope of the present disclosure. Further descriptions of the features, components, configuration, operations, and implementations of the example embodiments of the present disclosure are provided in the following.

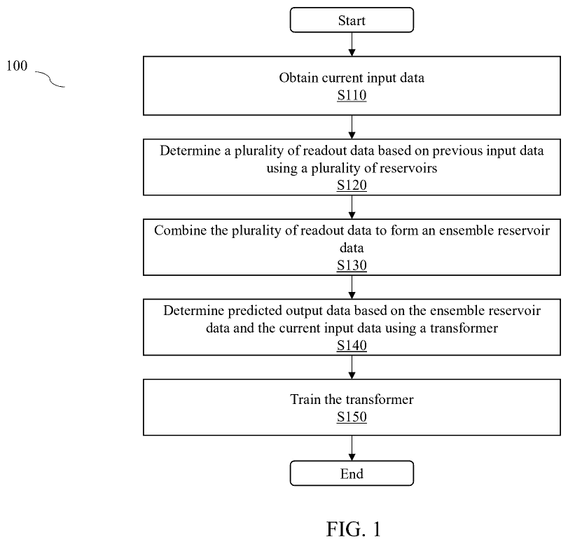

FIG. 1 illustrates a flow diagram of an example method 100 for enhancing future prediction using a reservoir transformer, according to one or more example embodiments. One or more operations in method 100 may be performed by a system. The system may be configured to enhance future prediction using a reservoir transformer. In particular, according to example embodiments, one or more operations in method 100 may be performed by at least one processor (e.g., processor 3612) of the system.

As illustrated in FIG. 1, at operation S110, the system may be configured to obtain current input data representing a current state of a complex system.

The complex system may include any kind of systems comprising a large number of interdependent variables, where the actions and behaviors of the variables together shape the behavior of the complex system as a whole. For example, the complex system may include time series regression tasks, time series classification tasks, and the like. According to example embodiments, the complex system may include one or more of: traffic, weather, exchange rate, electricity, air quality, electricity transformer temperature (ETT) (e.g., ETTh1, ETTh2, ETTm1, ETTm2, etc.), and in-line inspection (ILI).

In this regard, the current state of the complex system may represent a state of the complex system at a current time. For example, the current state of the traffic may represent the state of the traffic at a current time (e.g., congestion level, etc.), while the current state of the weather may represent the state of the weather at a current time (e.g., cloudy, rainy, etc.)

Here, the system may consider a time series data comprising a vector of features represented by \vec{u}(t) containing c components (i.e., features, such as temperature, humidity, etc associated with a complex system), and a corresponding label represented by \vec{y}(t). The time series data may be defined with time t∈T, where T represents a total time step in a finite history, and where the vector of features at time step t (i.e., \vec{u}(t)) may correspond to the label at time step t (i.e., \vec{y}(t)).

In this regard, the vector of features at time step t may correspond to the vector of features representing a state of the complex system at a particular time, while the corresponding label at time step t may correspond to the label representing a state of the complex system at a time after the particular time. For example, if the complex system corresponds to weather, at time step 5, \vec{u}(5) may correspond to the vector of features representing cloudy weather at 10 am, while \vec{y}(5) may correspond to the label “sunny” at 11 am (here, \vec{u}(6) may correspond to the vector of features representing sunny weather at 11 am). The above relationship exemplifies the prediction nature of the system, where the vector of features at a particular time is used as input to predict the label at a time after the particular time.

In view of the above, the obtained current input data may include the vector of features representing the current state of the complex system (i.e., the state of the complex system at the current time). According to example embodiments, the current input data may be represented as \vec{u}(t+1).

In this regard, the goal of example embodiments of the present disclosure (described below in relation to operation S140) may be to determine \vec{y}(t+1) which represents the label representing a state of the complex system at a time after the current time. In particular, \vec{y}(t+1) may represent the class or value of a future time step given t sequential multivariate history \vec{u}(1: t+1) and \vec{y}(1: t). The method then proceeds to operation S120.

At operation S120, the system may be configured to determine a plurality of readout data based on previous input data representing a previous state of the complex system using a plurality of reservoirs. According to example embodiments, the system may be configured to determine the plurality of readout data based on the previous input data in combination with an attention mechanism using the plurality of reservoirs.

The plurality of readout data may include a plurality of non-linear readout data or a plurality of linear readout data. Further, the attention mechanism may include self-attention or cross attention.

The previous input data may include vector of features representing the previous state of the complex system (i.e., the state of the complex system at a previous time before the current time). According to example embodiments, the previous input data may include vector of features representing all previous states of the complex system (i.e., all states of the complex system from an initial time (e.g., corresponding to \vec{u}(1)) to a previous time before the current time). According to example embodiments, the previous input data may be represented as \vec{u}(t).

In this regard, according to example embodiments, the previous input data may be provided as input to each of the plurality of reservoirs, where each of the plurality of reservoirs may produce non-linear readout data from the previous input data based on an algorithm.

The reservoir may refer to a reservoir under a reservoir computing, which may include a class of simple and efficient recurrent neural network (RCC) where internal weights are fixed at random and only the output layer is trained. The role of the reservoir may be to convert the previous input data into a high-dimensional space so that a relatively simple learning algorithm can efficiently read out the features of the inputs.

According to example embodiments, the reservoir may refer to a reservoir under echo state network (ESN) reservoir computing (i.e., the plurality of reservoirs may include echo state network (ESN) reservoirs). In this regard, example embodiments of the present disclosure may be model agnostic, where the reservoir (e.g., ESN) may be applied on any other neural network architecture, such as convolutional neural network and long short term memory (LSTM) to improve their performance.

The following descriptions detail an example process and algorithm for the plurality of reservoirs to produce the plurality of non-linear readout data from the previous input data.

According to example embodiments, the system may first determine, for each of the plurality of reservoirs, a reservoir state at the previous time based on the previous input data.

According to example embodiments, the reservoir state may be defined based on architecture described under deep reservoir computing (DCR) with echo state network (ESN) model. For example, the reservoir state may be defined and updated based on leaky integrator echo state network (LI-ESN) model according to the following state transition function.

$$\vec{x} ( t ) = ( 1 - a ) \vec{x} ( t - 1 ) + a tanh ( {\vec{W}}_{in} \vec{u} ( t ) + θ + \vec{\hat{W}} \vec{x} ( t - 1 ) ) \qquad ( 1 )$$

\vec{x}(t) may represent the reservoir state of a reservoir at time step t, and may be defined according to \vec{x}(t)∈Rⁿ, where n may represent the dimensionality of the reservoir state vector. α may represent a leaky parameter (i.e., decay rate of the nodes), and may be defined according to α∈[0,1]. The leaky parameter may enable regulation of the memory of the reservoirs, where smaller values may favor longer memory. tanh( ) may represent an element-wise applied hyperbolic tangent activation function. \vec{W}ᵢₙ may represent an input-to-reservoir weight matrix, and may be defined according to \vec{W}ᵢₙ∈^{c×n}, where c may represent the vector of features of the input sequence data, and where each element may be sampled uniformly from [−input scaling factor, input scaling factor]. θ may represent a bias-to-reservoir weight vector, and may be defined according to θ∈Rⁿ. \hat{\vec{W}} may represent a recurrent reservoir weight matrix, and may be defined according to \hat{\vec{W}}∈^{n×n}. Further, the \hat{\vec{W}} and θ may be generated randomly with elements drawn independently from, for example, a Gaussian distribution. It is noted that \vec{W}ᵢₙ, \hat{\vec{W}}, α, and θ may be different for each reservoirs, and \vec{W}ᵢₙ, \hat{\vec{W}}, and θ may not be updated during training. Further, the initial state may either be zero or randomly initialized. Furthermore, the leaky parameter a, as well as spectral radius may be tuned on the validation set using, for example, Powell's algorithm. Here, the spectral radius and sparsity may be initialized to satisfy the Echo State Property (ESP) and remain fixed during training.

According to example embodiments, the reservoir parameters may be initialized according to the constraints specified by echo state property (ESP) and may be left untrained, enabling efficient computing. According to example embodiments, the values for \vec{W}ᵢₙ and θ may be selected based on a uniform distribution over [−scaleᵢₙ, scaleᵢₙ], where scaleᵢₙ may represent an input scaling parameter. According to example embodiments, the values for \vec{W}ᵢₙ and \hat{\vec{W}} may be fixed and random, where each of \vec{W}ᵢₙ and \hat{\vec{W}} may be drawn according to a Gaussian distribution with parameterized variances.

According to example embodiments, the \hat{\vec{W}} matrix may constrain randomly selected values from a uniform distribution, and may then be adjusted such that the spectral radius of \hat{\vec{W}} matrix, which is represented as p, remains below 1 (i.e., p<1). Here, the \hat{\vec{W}} may be defined in accordance with the following formula.

$$\vec{\tilde{W}} = ( 1 - a ) I + a \vec{\hat{W}} \qquad ( 2 )$$

Once the reservoir state is determined, the system may determine, for each of the plurality of reservoirs, non-linear readout data at the previous time based on the corresponding reservoir state.

According to example embodiments, the non-linear readout data may be determined using the attention mechanism. The attention mechanism may enable processing of sequential data that considers context for each time step. For example, the non-linear readout sequence data may be determined in accordance with the following functions.

$${h}_{i , j} = tanh ( {\vec{x} ( t )}_{i}^{T} {\vec{W}}_{t} + {\vec{x} ( t )}_{j}^{T} {\vec{W}}_{x} + {b}_{i} ) \qquad ( 3 )$$

$${e}_{i , j} = σ ( {\vec{W}}_{a} {h}_{i , j} + {b}_{a} ) \qquad ( 4 )$$

$${γ}_{i , j} = \frac{exp ( {e}_{i , j} )}{{\sum }_{i = 1}^{J} ( exp ( {e}_{i , j} ) )} \qquad ( 5 )$$

$$r ( t ) = {\{ {\sum }_{j} {γ}_{i , j} {\vec{x} ( t )}_{j} \}}_{i = 1}^{c} \qquad ( 6 )$$

r(t) may represent the non-linear readout data of a reservoir at time step t, where the i and j subscripts may denote the ith and jth component of \vec{x}(t). \vec{W}ₜ, \vec{W}ₓ, \vec{W}ₐ, bᵢ, and bₐ may represent various weights and biases. tanh( ) may represent a non-linear activation hyperbolic tangent function. γ may correspond to an attention weight of the self-attention mechanism, which may be a softmax of e.

In view of the above, the plurality of non-linear readout data may be obtained (determined) from the plurality of reservoirs.

The following descriptions detail an example process and algorithm for the plurality of reservoirs to produce the plurality of linear readout data from the previous input data.

According to example embodiments, the system may first determine, for each of the plurality of reservoirs, a reservoir state at the previous time based on the previous input data, in the similar manner as described above in relation to equations (1) and (2).

Once the reservoir state is determined, the system may determine, for each of the plurality of reservoirs, linear readout data at the previous time based on the corresponding reservoir state. For example, the linear readout sequence data may be determined in accordance with the following functions.

$$d ( t ) = {\vec{W}}_{out} {\vec{x} ( t )}^{T} + {θ}_{out} \qquad ( 7 )$$

d(t) may represent the linear readout data, and may be defined according to d(t)∈R^{m}, where m may represent the dimensionality. \vec{W}ₒᵤₜ may represent the reservoir-to-readout weight matrix connecting the reservoir units to the units in the readouts, and may be defined according to \vec{W}ₒᵤₜ∈R^{n×m}. In this regard, only the \vec{W}ₒᵤₜ may be trained, and the optimization problem boils down to linear regression. θₒᵤₜ may represent the bias-to-readout weight vector, and may be defined according to θₒᵤₜ∈R^{m}.

According to example embodiments, the readout data may be trained by solving a linear regression problem using, for example, Moore-Penrose pseudo-inversion technique. The method then proceeds to operation S130.

At operation S130, the system may be configured to combine the plurality of readout data to form an ensemble reservoir data.

In particular, according to example embodiments assuming Q reservoirs in the plurality of reservoirs, equations (1) and (6) described above may be utilized to obtain Q non-linear readout data during operation S120. Then, the Q non-linear readout data may be combined to produce the ensemble reservoir data in accordance with the following formula.

$$\vec{o} ( t ) = {r}^{1} ( t ) + {r}^{1} ( t ) + … + {r}^{Q} ( t ) \qquad ( 8 )$$

σ(t) may represent the ensemble reservoir data at time step t. r^{l}(t) may represent the non-linear readout data from attention mechanism of the lth reservoir within Q obtained during operation S120. Here, the notation (+) may indicate element wise addition to all reservoir's outputs. It is also noted that, according to example embodiments, the Q reservoirs may have distinct decay rates (i.e., leaky parameter a and spectral radius p), which may be initialized randomly.

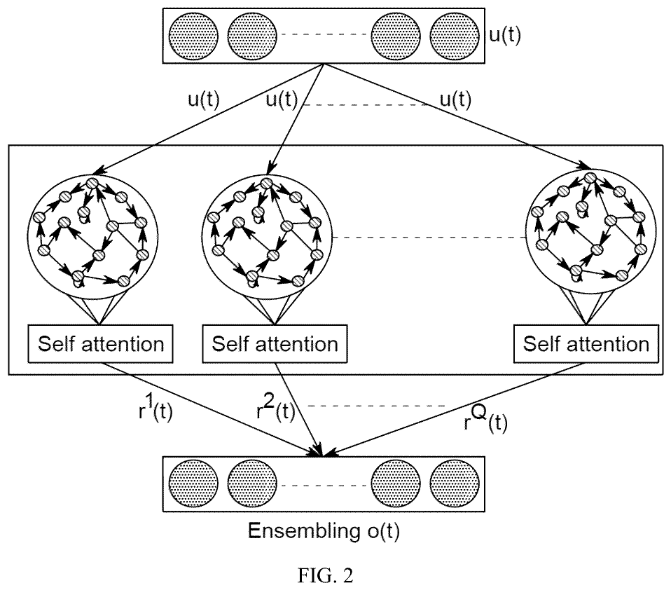

FIG. 2 illustrates a block diagram of a visual representation of a process to obtain the ensemble reservoir data, according to one or more example embodiments.

As shown in FIG. 2, the process to obtain the ensemble reservoir data may first involve feeding the previous input data \vec{u}(t) to each of the plurality of reservoirs, where the plurality of reservoirs may then process the previous input data individually to produce non-linear readout data r(t), in the similar manner as described above in relation to operation S120. Subsequently, the plurality of non-linear readout data may be combined to form the ensemble reservoir data \vec{o}(t), in the similar manner as described above in relation to operation S130.

Alternatively, according to example embodiments assuming Q reservoirs in the plurality of reservoirs, equations (1) and (7) described above may be utilized to obtain Q linear readout data during operation S120. Then, the Q linear readout data may be combined to produce the ensemble reservoir data in accordance with the following formula.

$$\vec{o} ( t ) = {d}^{1} ( t ) + {d}^{1} ( t ) + … + {d}^{Q} ( t ) \qquad ( 9 )$$

d^{l}(t) may represent the linear readout data of the lth reservoir within Q obtained during operation S120. Here, the notation (+) may indicate element wise addition to all reservoir's outputs. The method then proceeds to operation S140.

At operation S140, the system may be configured to determine predicted output data representing a predicted state of the complex system based on the ensemble reservoir data and the current input data using a transformer.

In particular, the ensemble reservoir data and the current input data may be provided as input to the transformer, where the transformer may produce the predicted output data from the ensemble reservoir data and the current input data based on an algorithm.

The predicted output data may include the label representing the predicted state of the complex system. According to example embodiments, the predicted output data may be represented as \vec{y̅}(t+1).

In this regard, the predicted state of the complex system may represent a state of the complex system at a time after the current time that is predicted/forecasted. For example, the predicted state of the traffic may represent the state of the traffic in the future after the current time (e.g., lower congestion level, etc.), while the current state of the weather may represent the state of the weather in the future after the current time (e.g., sunny, etc.)

The following descriptions detail an example process and algorithm for the transformer to produce the predicted output data from the ensemble reservoir data and the current input data, where the ensemble reservoir data is formed from the plurality of non-linear readout data.

According to example embodiments, the system may first determine a transformer input for determining the predicted state of the complex system based on the ensemble reservoir data and the current input data. For example, the transformer input may be defined according to the following function.

$$\vec{z} ( t + 1 ) = k \vec{u} ( t + 1 ) + ( 1 - k ) \vec{o} ( t ) \qquad ( 10 )$$

\vec{z}(t+1) may represent transformer input for determining the predicted state of the complex system. k may represent a learnable parameter indicating the weights of current multivariate states and reservoir states to predict (i.e., by equation 11 below). \vec{u}(t+1) may represent the current input data obtained during operation S110. \vec{o}(t) may represent the ensemble reservoir data obtained during operation S130 according to equation (8).

Once the transformer input is determined, the system may determine the predicted output data based on the transformer input using the transformer. For example, the predicted output data may be defined in accordance with the following function.

$$\overline{\vec{y}} ( t + 1 ) = M ( \vec{z} ( t + 1 ) ) \qquad ( 11 )$$

\vec{y̅}ᵢ(t+1) may represent the predicted output data. M( ) may represent the encoder function of the transformer. \vec{z}(t+1) may represent transformer input obtained above.

In view of the above, the predicted output data may be obtained (determined) from the transformer.

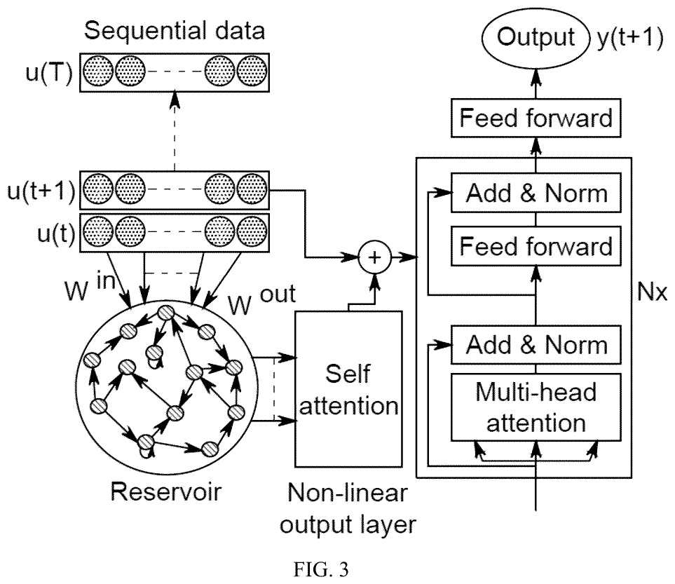

FIG. 3 illustrates a block diagram of a visual representation of a process to obtain the predicted output data, according to one or more example embodiments.

As shown in FIG. 3, the process to obtain the predicted output data may first involve combination of the current input data \vec{u}(t+1) with the ensemble reservoir data \vec{o}(t). Such combination may then serve as input to the transformer architecture Nx, which may process the input to produce the predicted output data \vec{y̅}(t+1), in the similar manner as described above in relation to operation S140.

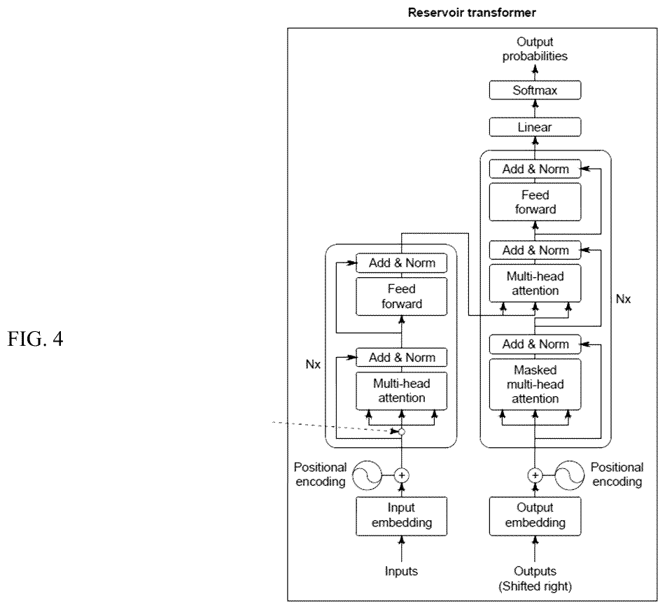

FIG. 4 illustrates a block diagram of a visual representation of a general abstract structure corresponding to the process to obtain the predicted output data, according to one or more example embodiments.

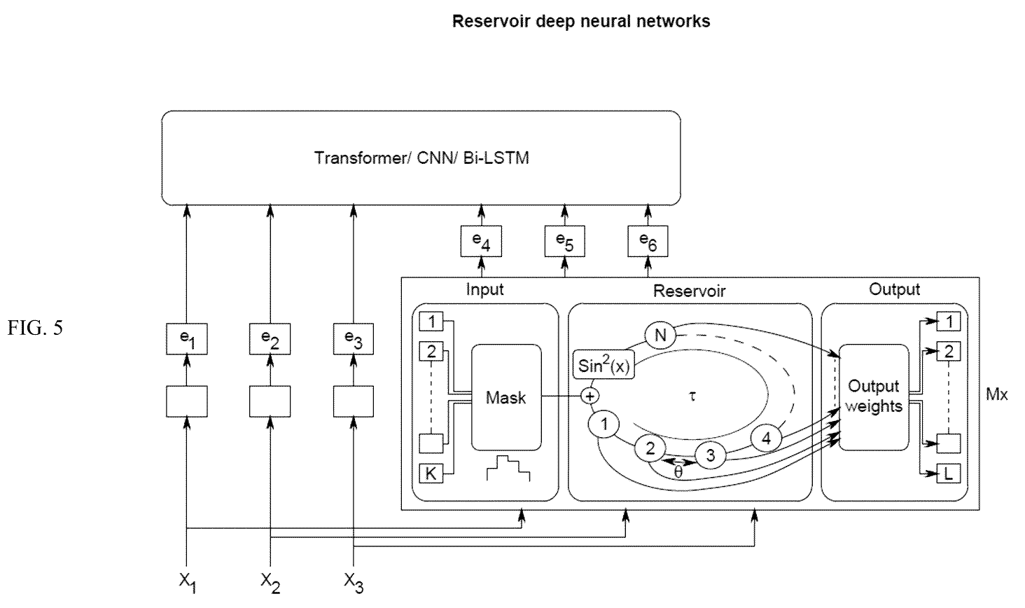

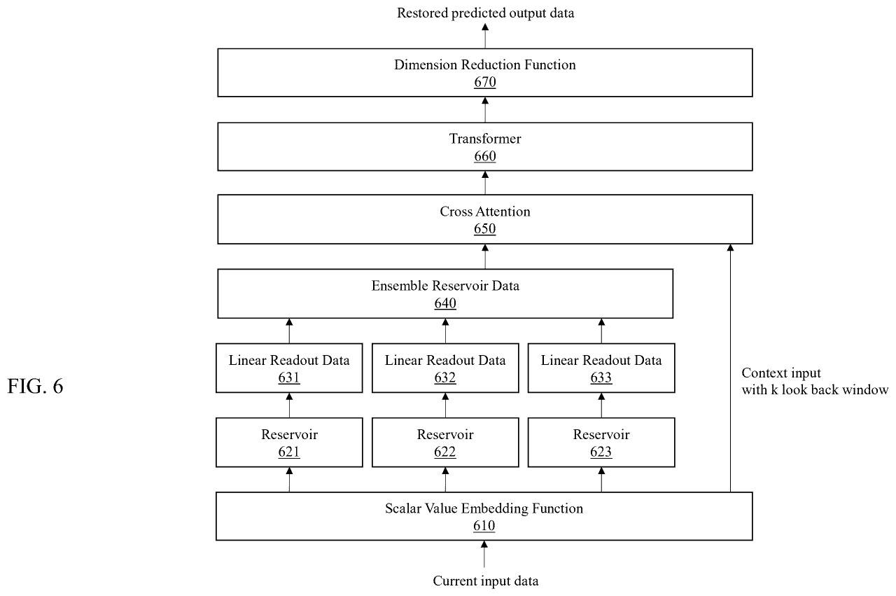

FIG. 5 illustrates a block diagram of a visual representation of a reservoir deep neural networks, according to one or more example embodiments. The flow of data shown in FIG. 5 represents an abstract structure corresponding to the process from 610 to 660 in FIG. 6 described below.

The following descriptions detail an example process and algorithm for the transformer to produce the predicted output data from the ensemble reservoir data and the current input data, where the ensemble reservoir data is formed from the plurality of linear readout data.

According to example embodiments, the predicted output data may be determined based on the ensemble reservoir data and the current input data using the transformer and a cross-attention mechanism.

According to example embodiments, the system may first determine a transformer input for determining the predicted state of the complex system based on the ensemble reservoir data and the current input data. Here, the transformer input may be determined based on the ensemble reservoir data and the current input data using cross attention. For example, the transformer input may be defined according to the following function.

$$\vec{z} ( t + 1 ) = soft max ( \frac{( \vec{u} ( t + 1 ) {\vec{W}}_{Q} ) {( \vec{o} ( t ) {\vec{W}}_{K} )}^{T}}{\sqrt{{q}_{k}}} ) ( \vec{o} ( t ) {\vec{W}}_{V} ) \qquad ( 12 )$$

\vec{o}(t) may represent the ensemble reservoir data obtained during operation S130 according to equation (9). qₖ may represent the dimension of keys in the cross-attention. \vec{W}_{Q} may represent queries weight. \vec{W}_{K} may represent keys weights. \vec{W}_{V} may represent values weights. W_{Q}, \vec{W}_{K}, and \vec{W}_{V} may be learnable, and may be initialized randomly.

Once the transformer input is determined, the system may determine the predicted output data based on the transformer input using the transformer, in the similar manner as described above in relation to equation (11). The method then proceeds to operation S150.

At operation S150, the system may be configured to train the transformer.

According to example embodiments, the transformer may be trained based on the predicted output data and a corresponding true output data using a loss function.

Here, the predicted output data may include the label representing the state of the complex system at a time after the current time that is predicted/forecasted (predicted state) which is obtained during operation S140, while the corresponding true output data may include the label representing the state of the complex system at a time after the current time that actually occurred (i.e., true value/ground truth).

According to example embodiments, the transformer (i.e., encoder function of the transformer M( )) may be sequentially trained across all time steps 1:T using training dataset. Subsequently, the transformer may be fine-tuned using validation dataset to achieve optimal model performance. The transformer may also be subjected to testing with varying hyper-parameters, such as reservoir size, leaky rate, spectral radius, reservoir number, learning rate, attention size, transformer block, dropout rate, and the like. The selection of the hyper-parameters may be based on specific dataset employed.

In this regard, according to example embodiments, the transformer may be trained based on a loss function (objective), such as Huber loss function, defined in accordance with the following function.

$$Loss ( \vec{y} , \overline{\vec{y}} ) = \frac{1}{T} {\sum }_{i = 1}^{T} \{ \begin{matrix}\frac{1}{2} {( {\vec{y}}_{i} - {\overline{\vec{y}}}_{i} )}^{2} & if \vert {\vec{y}}_{i} - {\overline{\vec{y}}}_{i} \vert \leq δ \\ δ \vert {\vec{y}}_{i} - {\overline{\vec{y}}}_{i} \vert - \frac{1}{2} δ , & otherwise\end{matrix} , \qquad ( 13 )$$

δ may represent an adjustable parameter that controls where the function change occurs to keep the function differentiable. T may represent the total number of samples. \vec{y}, \vec{y̅} may represent ground truth and predicted values, respectively.

Alternatively, according to example embodiments, the transformer may be trained based on a loss function (objective), such as cross-entropy loss function, defined in accordance with the following function.

$$Loss ( \vec{y} , \overline{\vec{y}} ) = \frac{1}{T} {\sum }_{t = 1}^{T} {\vec{y}}_{t} log ( {\overline{\vec{y}}}_{t} ) \qquad ( 14 )$$

In this regard, loss may be calculated for every time step by comparing the predicted output data with actual output data using the loss function described in equation 13 and 14. Subsequently, parameters σ in equation 4 above and ϑ in equation 17 below may be updated to minimize the loss.

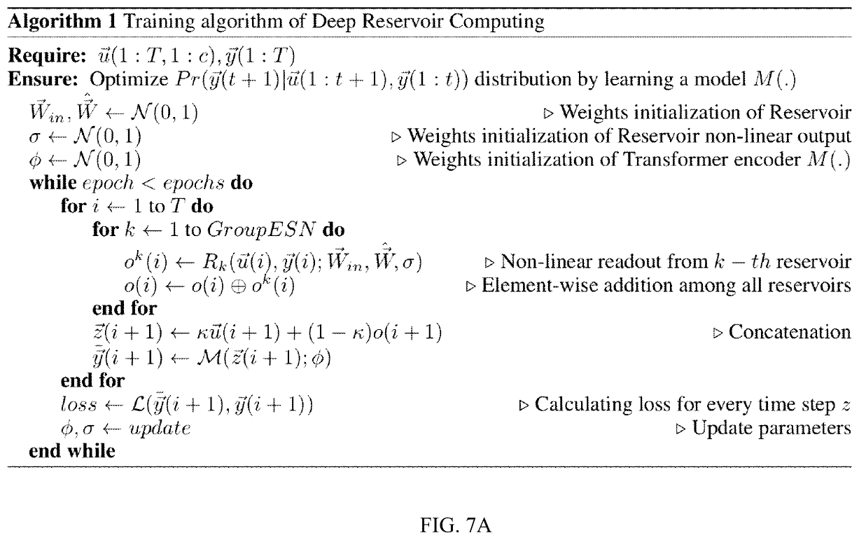

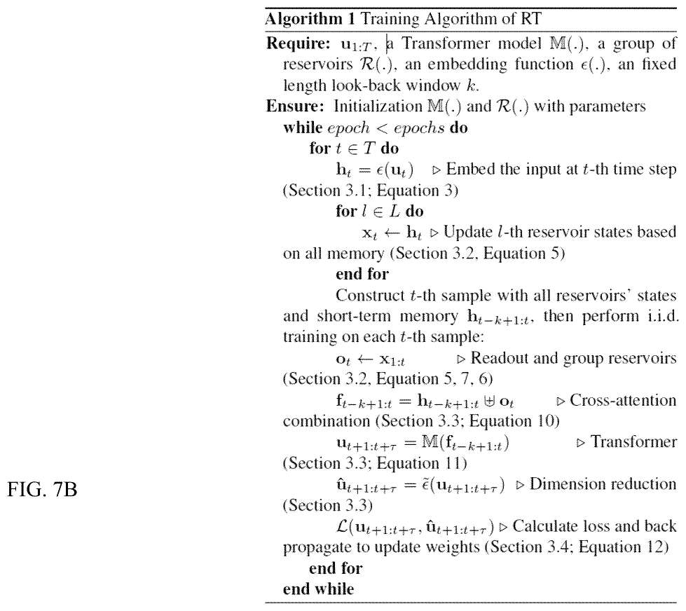

FIG. 7A illustrates an algorithm for training the transformer, according to one or more example embodiments. The algorithm shown in FIG. 7A may involve non-linear readout data and self-attention, and may be utilized for training any deep reservoir computing model with the goal of optimizing the distribution of target variables \vec{y}(t+1), given the input variables \vec{u}(1: t+1) and previous target variables \vec{y}(1: t). The algorithm initializes the weights of the reservoir \vec{W}ᵢₙ and Ŵ, as well as the weights of the non-linear output σ and transformer encoder ϑ, as random variables sampled from a normal distribution with mean 0 and standard deviation 1.

The algorithm then enters an outer loop, where the number of iterations is determined by the number of epochs. Within this loop, there is an inner loop that iterates through each time step, i, from 1 to T. For each time step, a group of reservoirs, Group ESN, are processed in parallel. Each reservoir Rₖ receives the input {right arrow over (u()}i) and the previous target variable \vec{y}(i) as inputs, and calculates non-linear readout data o^{k} (i) using the weights \vec{W}ᵢₙ, Ŵ, and σ. The readouts from all reservoirs are then element-wise added together to produce o(i).

The input of the next time step \vec{u}(i+1) is concatenated with the readout from the reservoir o(i) using parameter k to produce \vec{z}(i+1). Finally, the transformer encoder function M( ) is applied to \vec{z}(i+1) using the parameter ϑ to produce the target variable for the next time step \vec{y}(i+1). The loss is then calculated for every time step z, by comparing the predicted target variable \vec{y̅}ᵢ(1: T) with the true target variable \vec{y}(1: T), using the loss function Loss( ). The parameters a and P are then updated to minimize the loss.

According to example embodiments, the system may be configured to perform embedding. According to example embodiments, the embedding may include scalar value embedding. The system may perform scalar value embedding by mapping each scalar feature value into a fixed-dimensional feature vector using a scalar value embedding function. Further, the system may perform scalar value embedding based on scalable numerical embedding (SCANE) technique. Here, while the below description is provided while referring to scalar value embedding, it is understood that the present disclosure is not limited thereto, and may encompass other kinds of embedding.

In particular, the current input data \vec{u}(t+1) may be raw data, where each observation at time t consists of multiple features, such as temperature, humidity, and the like. Each feature may be represented as a single scalar value. However, these scalar values may not fully capture the semantic meaning of the features. For instance, a temperature of 0° F. and 100° F. may share more common properties compared to 0° F. and 50° F., because both 0° F. and 100° F. show extreme weather conditions and can have similar impacts on transportation. Understanding the semantic meaning of each feature in the context of the task can help in learning temporal patterns and relationships, leading to better generalization. This becomes especially important when the long-term and short-term memory of equal size are combined. In this regard, the time-series data may be embedded by mapping each scalar feature value into a fixed-dimensional feature vector, resulting in a richer, more meaningful feature representation, which makes it easier to identify common patterns for better predictions.

Further, the SCANE technique supports fine-tuning, allowing adaptation to specific datasets. The scalar values may be converted from the current time step into vector representations and apply embedding to time series data in a manner analogous to language embedding. For example, for weather datasets, SCANE technique may transform the scalar wind-speed value into a 20-dimensional vector representation. After fine-tuning the embedding on the specific dataset, these vectors may be multiplied by the numeric feature value to reflect the actual magnitude in the vector representation for a more adequate learning.

According to example embodiments, the system may also be configured to perform embedding restoration decoding. The system may perform embedding restoration decoding by applying a dimension reduction function on the predicted output data. In particular, according to example embodiments, the system may perform embedding restoration decoding by applying a single layer feedforward multi-perceptron layer with ReLU activation functions.

In particular, the predicted output data \vec{y̅}(t+1) may be in a higher dimension space due to the scalar value embedding. As such, the embedding restoration decoding may be performed to restore the output back to scalar values, matching the feature sets in the original data. Here, the single layer feedforward multi-perceptron layer may implement a dimension reduction function on the output \vec{y̅}(t+1) obtained from equation (11).

FIG. 6 illustrates an example flow of data involving scalar value embedding and embedding restoration decoding, according to one or more example embodiments. The flow of data shown in FIG. 6 may involve linear readout data and cross attention.

As shown in FIG. 6, the flow of data may first involve obtaining the current input data, where the current input data may be inputted to perform the scalar value embedding to produce into a fixed-dimensional feature vector of the current input data. The fixed-dimensional feature vector of the current input data may then be inputted into a plurality of reservoirs to produce a plurality of linear readout data, in the similar manner as described above in relation to operation S120. Subsequently, the plurality of linear readout data may be combined to form the ensemble reservoir data with cross attention mechanism, the output of which may then be fed into the transformer to produce the predicted output data, in the similar manner as described above in relation to operation S130 to S140. Finally, the predicted output data may be inputted to perform the embedding restoration decoding.

It is noted here that the dimension reduction function, transformer, cross attention parameters, non-linear readout data, and scalar value embedding function may be trainable, while the reservoir parameters (e.g., \vec{W}ᵢₙ, \hat{\vec{W}}, α, and θ) may be frozen. It is also noted here that the cross attention may consider input representing long context that is provided from the plurality of reservoirs, as well as input representing short context that is provided from the scalar value embedding function. The input representing short context here may include k previous embedded time step retrieved to formulate the input representing short context from t−k to t.

FIG. 7B illustrates an algorithm for training the transformer, according to one or more example embodiments. The algorithm shown in FIG. 7B may involve linear readout data and cross-attention, as well as scalar value embedding and embedding restoration decoding.

The algorithm initiates by setting parameters for both the transformer and the reservoir groups. During each training epoch, the algorithm processes sequences incrementally from a specified start time k up to the total length T. Each sequence segment transforms an embedded vector, which is then input into the reservoirs to produce intermediate representations.

Specifically, for each time step t, the reservoir output will be updated in a streaming manner, reading current values hₜ and the reservoir outputs from each reservoir in last time step (xₜ−1) as inputs to update and generate the latest reservoir state (xₜ) for each reservoir model. Then, through linear readout and concatenation with other outputs from different reservoirs, the intermediate representations o was formulated. These are subsequently combined with the original embedded input through cross attention operation, forming a composite vector. This vector is fed into the transformer to predict future sequence values. The training cycle completes by calculating loss between the predicted and actual values and updating the model parameters accordingly, aiming to minimize prediction errors in following epochs.

Upon performing operation S150, the method 100 may be ended or be terminated. Alternatively, method 100 may return to operation S110, such that the at least one processor may be configured to repeatedly perform, for at least a predetermined amount of time, the obtaining the current input data (at operation S110), the determining the plurality of non-linear readout data (at operation S120), the combining the plurality of non-linear readout data (at operation S130), the determining the predicted output data (at operation S140), and the training the transformer (at operation S150).

Further, while the above and below descriptions are provided in relation to a transformer, the present disclosure is not limited thereto, and may encompass any kind of deep neural network (DNN) architecture other than the transformer. According to example embodiments, the transformer may be a pre-trained language model.

Accordingly, the above processes enable prediction of future trends of a complex system with machine learning, while addressing challenges related to the sensitivity of initial conditions and the input length limitation. In particular, the use of a reservoir to produce non-linear readout data (which is fed into the transformer) allows the transformer to efficiently handle any arbitrary length of input (or infinite number of input tokens), where the plurality of reservoirs further reduce the uncertainty caused by the initial conditions. This subsequently provides a highly effective solution for performing extremely long-term chaotic prediction.

More specifically, reservoir computing enables processing of temporal data within the context of chaotic time series prediction in a simple and computationally efficient manner. This enables an effective modelling of sequences of input with arbitrary lengths, capturing of intricate dependencies across all temporal events without window sized context restrictions, as well as discerning of sequence of events based on all historical data. The transformer is then utilized to digest short-term event chronicles, melding its insights with those of the reservoir to produce the final forecast. This paradigm departs from conventional heuristic assumptions, ushering in a structured method that propels transformative changes in chaotic forecasting domain.

In relation to the input length limitation, the number of reservoir nodes scales quadratically with the reservoir output size, which in turn corresponds to the length of the input to be fed into the transformer (or other deep neural network (DNN) model). To efficiently manage longer sequences and allow transformer to process any input length, the non-linear readout data (which is rooted in single-head attention mechanism) is utilized as output from the reservoirs and input to the transformer, rather than the traditional linear readout data. Such non-linear readout data provides heightened expressiveness and essentially performs a dimensionality reduction on reservoir outputs, thus providing the transformer with more meaningful and potent feature inputs.

Specifically, traditional time-series forecasting often only handle fixed input length with an assumption of looking back s window size, and considering (t−s) history to predict the result at t instead of using the complete history. As such, the prediction of the output sequence data \vec{y}(t+1) given \vec{u}(t−s: t+1) and \vec{y}(t−s: t) may be expressed as.

$$Pr ( \vec{y} ( t + 1 ) \vert \vec{u} ( t - s : t + 1 ) , \vec{y} ( t - s : t ) ; ϑ ) \qquad ( 15 )$$

Here, ϑ may represent the learnable parameters shared by all time steps T to predict the conditional probability. The reason to introduce s is that learning this conditional probability typically depends on s. In this regard, the computational cost and complexity for the transformer to perform prediction may be a quadratic to the s, and may be expressed as O(s²×c).

Here it is noted that, in transformers, the architect unravels the temporal dependencies into individual time steps. At each time step of training, parameter ϑ may be optimized by the transformer encoder function M( ) to learn the distribution in the equation 15. In this regard, the transformer input of traditional transformers may be defined according to the following function.

$$\vec{g} ( t + 1 ) = k \vec{u} ( t + 1 ) + ( 1 - k ) ( \vec{u} ( t - s : t ) , \vec{y} ( t - s : t ) ) \qquad ( 16 )$$

k may represent the learning parameter adjusting the weights of the current time step input \vec{u}(t+1) and the previous s time step input \vec{u}(t−s: t), \vec{y}(t−s: t). In this regard, employing \vec{g}(t+1) as the input for the transformer encoder function M( ) poses issues. In particular, the transformer's input length is constrained by a factorization approach involving a retrospective window of size s, thereby increasing computational complexity. Further, the transformer imposes restrictions on input length, preventing it from exceeding the value of s due to quadratic time complexity considerations. Consequently, the incorporation of extensive historical data becomes impractical, limiting its potential impact on the learning and decision-making processes.

To avoid the costly operation and address the input length issue, the reservoir (e.g., deep reservoir computing) may be introduced. The reservoir enables preservation of all history for prediction, and thus, enables estimation of conditional distribution with any length input. Accordingly, the determination of predicted output data \vec{y}(t+1) in accordance with the transformer encoder function MO may be expressed as.

$$Pr ( \vec{y} ( t + 1 ) \vert \vec{u} ( 1 : t + 1 ) , \vec{y} ( 1 : t ) ; ϑ ) \qquad ( 17 )$$

In this regard, assuming the reservoir has m size of output vector, the computational cost and complexity for the transformer to perform prediction may now be expressed as O((k+m)²×c), where k here may represent the size of a look-back window that is smaller in comparison to s.

In other words, in the traditional time-series forecasting, to predict the future at current time step t+1 (i.e., \vec{y}(t+1)), features from only previous s time step up to current time step t+1 (i.e., \vec{u}(t−s: t+1)) and the label from only previous s time step up to previous time step t (i.e., \vec{y}(t−s: t)) are considered. On the other hand, by employing the reservoir in the example embodiments of the present disclosure, to predict the future at current time step t+1 (i.e., \vec{y}(t+1)), all features from the initial time step 1 up to current time step t+1 (i.e., \vec{u}(1: t+1)) and all label from the initial time step 1 up to previous time step t (i.e., \vec{y}(1: t)) are considered.

It is noted that a readout component may be used to linearly combine the outputs of all the reservoir units, for example, in accordance with ESN. As such, the output of a reservoir with linear readout data at each time step t may be defined and determined by the system in the similar manner as described above in relation to equation (7).

Accordingly, when the reservoir is combined with a transformer model, the computational cost and complexity for the transformer to perform prediction may be expressed as O((k+m)²×c), as described above. The reservoir may treat each time step individually, thus effectively manage lengthy inputs by keeping the entire history in its learning process without making the input longer. On the other hand, the training time of the transformer may increase quadratically with the input length as more time steps are included in the input, thus making the reservoir a better choice to handle long sequence of input data than the transformer.

Nevertheless, one downside of the reservoir is that if the reservoir output size m is large, the training of the transformer may still be slow due to its quadratic complexity. In this regard, since non-linear readout data of a reservoir has more expressive power than linear readout data and the linear readout data needs a much larger size to have the same expressive power as the non-linear readout data, the non-linear readout data may be utilized. The non-linear readout data is effective in reducing output dimension and improving prediction performance and accuracy, as well as providing faster convergence and reducing the possibility of getting stuck in a local optimum.

Further, to model the non-linear readout data, the attention mechanism may be utilized to capture input feature importance and alleviate the problem of vanishing gradient of long-distance dependency. The attention mechanism may also enable processing of sequential data that considers the context for each time step. More specifically, reservoirs, while efficient, lack precision in learning local event relationships across time steps. To overcome this, the attention mechanism, such as cross-attention mechanism, may be employed to integrate compressed long-term memory (from the reservoir's non-linear readout data) with recent short-term inputs. This forms a sample combining insights from both long-term and short-term patterns, which may then be fed into the transformer for training. This approach enables more accurate forecasting by emphasizing recent data while maintaining historical context. In addition, the number of reservoir states may also scale quadratically with the output size (corresponding to the transformer's input size), necessitating a large linear readout and increasing overall complexity. Here, example embodiments of the present disclosure utilizing non-linear readout data and attention mechanism can effectively reduce the linear readout size while preserving the model's ability to capture both long-term and short-term patterns.

It is also noted here that the reservoir learning may involve processing input in a streaming fashion and may require no training of updating reservoir states, as the reservoir weights may be frozen. At each time step, the reservoir may update its states based on all historical data memorized in previous states as described in equation (1), then a fixed size linear readout layer may retrieve these states and output the non-linear readout data as described in equations (3)-(6). Reading the input and processing it in a streaming manner may result in linear time complexity and constant space complexity relative to the input length, enabling the handling of arbitrary context lengths.

In relation to the sensitivity of initial conditions, the use of multiple reservoirs where outputs are combined together (the ensemble learning with multiple reservoirs) helps address and circumvent this issue, elevating prediction precision and consistency. The multiple reservoirs enable consistent capturing and retaining of inputs from all prior time steps, laying a robust foundation for continuous time step learning and enabling efficient long-term context assimilation. The multiple reservoirs also efficiently model observed time-series data in dynamical systems, as well as require minimal training data and computational resource, making them ideal for handling long sequential inputs.

Following this, the output from the multiple reservoirs seamlessly integrates with the observation of the present time step, subsequently being routed to DNNs (e.g., transformer), facilitating short-term context comprehension. By employing the multiple reservoirs, long-term time step interconnections may be efficiently discerned through the sophisticated training capabilities of the multiple reservoirs while simultaneously leveraging DNNs for the nuanced learning of contemporaneous features. In other words, while the transformer may capture temporal dependencies that it limited by the window size s, the use of multiple reservoirs overcomes this limitation, while enabling comprehensive modeling of entire historical data in decision-making.

In the context of multivariate time series prediction, the target label for forecasting up to q future time steps may be expressed as \vec{u}(t+1: t+1+q; v), which may be contingent upon the observed series \vec{u}(1: t). Further, all available features may be taken into account with the conditional distribution expressed as.

$$Pr ( \vec{u} ( t + 1 : t + 1 + q ) \vert \vec{u} ( 1 : t ) ; ϑ ) \qquad ( 18 )$$

In addition, due to the randomized nature of the reservoir network, each reservoir may yield varying model performance causing instability. In this regard, the ensemble learning using multiple reservoirs can alleviate such issue. Each reservoir within the group may be randomly initialized, and their collective output may be seamlessly integrated with the observations of recent events to generate the input for the transformer model. This ensemble technique not only enhances stability but also improves the model's overall predictive performance and effectively mitigates the impact of any single poor initialization, enhances generalization and the reliability of the model's predictions.

As discussed above, example embodiments of the present disclosure provide various improvements over the solutions in the related art. The following provides a description on experimental results from the implementation of the features of example embodiments of the present disclosure.

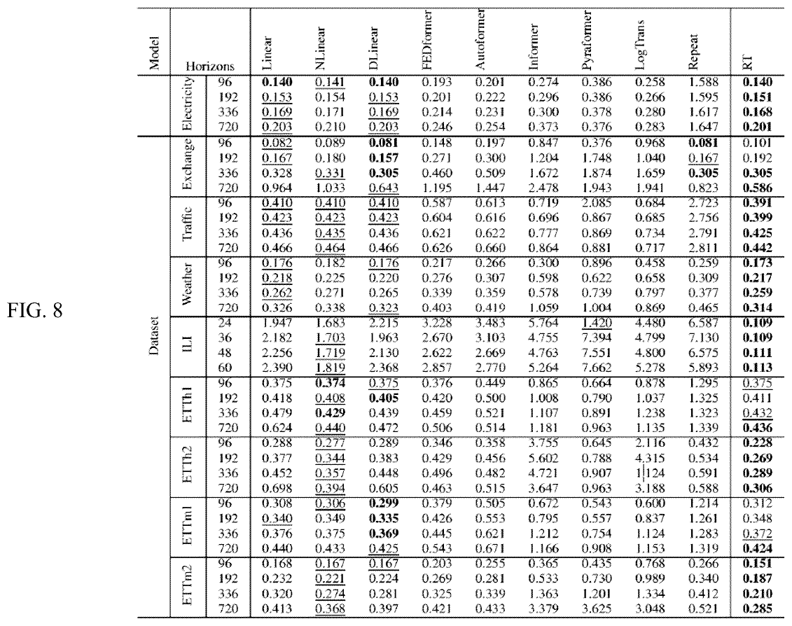

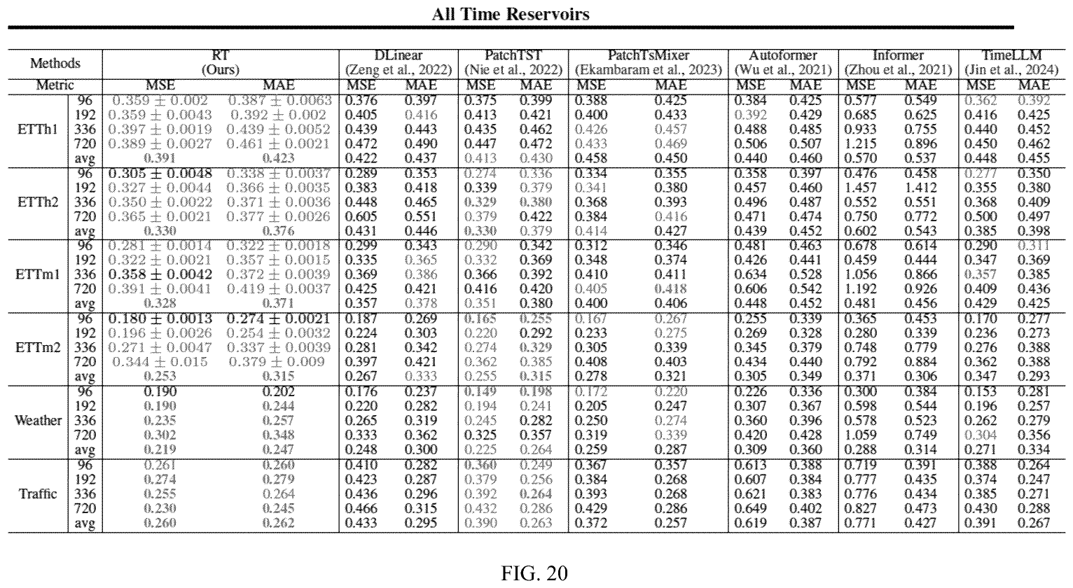

In particular, descriptions on experimental results from the implementation of features associated with the non-linear readout data and the plurality of reservoirs (ensemble reservoirs) to a transformer according to one or more example embodiments described above in relation to method 100 are described first in relation to FIG. 8 to FIG. 19, followed by descriptions on experimental results from implementation of features associated with the linear readout data and the plurality of reservoirs (ensemble reservoirs) to a transformer according to one or more example embodiments described above in relation to method 100 in relation to FIG. 20 to FIG. 28.

The implementation of features associated with the non-linear readout data and the plurality of reservoirs (ensemble reservoirs) to a transformer according to one or more example embodiments described above in relation to method 100 (hereinafter reservoir transformer) consistently outperforms state-of-the-art DNN models in multivariate time series, including NLinear, Pyformer, Informer, Autoformer, and the baseline transformer, with an error reduction of up to −89.43% in various fields such as ETTh, ETTm, and air quality. Such results demonstrate that the prediction can be improved to a more adequate and certain one with an ensemble learning, achieving superior performance in forecasting chaotic phenomena and accurately predicting Lyapunov time steps across multiple horizons.

Empirical results demonstrate that the nonlinear readout data, when sourced from ensemble reservoirs, drastically refines the transformer's prowess in time-series predictions, registering an error reduction of up to 89.43%. Through experiments described herein below, the chaotic nature inherent in time-series datasets can be gauged, allowing for impressive handling of very long input lengths surpassing leading-edge DNNs.

Below description show experimental results of reservoir transformer compared to baselines, including state-of-the-art methods in time-series prediction, such as: Nlinear, FEDformer, Autoformer, Informer, Pyraformer, LogTrans, GRIN, BRITS, STMVL, M-RNN, ImputeTS, and Transformer. The experiments on multivariate time series below adhered to the established methodology, including data splitting, preprocessing, and setting horizon times. Description on result analysis is provided first, followed by ablation study.

The following provides a description related to result analysis. The reservoir transformer is thoroughly assessed on different time series regression tasks. These tasks include Electricity, Traffic, Weather, ETTh1, ETTh2, ETTm1, ETTm2, ILI, Exchange Rate, Air Quality, Daily website visitors (DWV), Daily Gold Price (DGC), Daily Demand Forecasting Orders (DDFO), and Bitcoin Historical Dataset (BTC). The performance of reservoir transformer is also tested on two-time series classification tasks, i.e., Absenteeism at work (AW) and Temperature Readings from IoT Devices (see details below regarding dataset and parameter configuration).

FIG. 8 illustrates a comparison of multivariate long-term forecasting errors using the Mean Squared Error (MSE) metric. The empirical evaluation shown in FIG. 8 was performed across various methods and datasets. For each dataset, a forecasting horizon was specified with ILI having horizons T∈{24, 36, 48, 60} and the rest having T∈{96, 192, 336, 720}. It is evident that the reservoir transformer consistently outperforms other methods, achieving the lowest MSE in most scenarios. The transformer-based methods also show competitive performance, with some of their results being underscored for distinction.

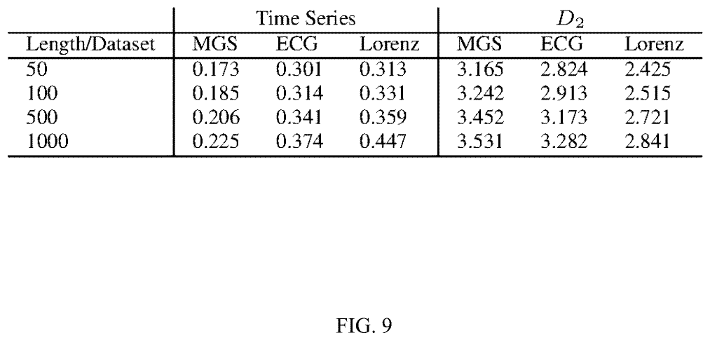

In order to investigate the presence of chaotic behavior and assess the predictive capabilities of the reservoir transformer according to example embodiments of the present disclosure, three distinct chaotic datasets were employed: the Mackey Glass Series (MGS), Electrocardiogram Signal (ECG), and Lorenz Attractor. The experiments involved horizons of 50, 100, 500, and 1000, as outlined in FIG. 9. In particular, FIG. 9 illustrates a comparison of Time Series Lengths and Correlation Dimensions (D₂) for Mackey Glass Series (MGS), Electrocardiogram Signal (ECG), and Lorenz Attractor datasets across varying lengths of 50, 100, 500, and 1000. Higher values of D₂ indicate increased complexity in the underlying dynamic.

To show that the datasets used are chaotic, the correlation dimension is employed, denoted as D₂, to serve as a reliable measure of chaotic behavior with higher values reflecting more pronounced chaos under the chaos theory. To evaluate the chaotic behavior of various time series datasets, D₂ may be defined in accordance with the following function.

$${D}_{2} = {lim}_{e \to 0} \frac{ln C ( ϵ )}{ln ϵ} \qquad ( 19 )$$

Here, the correlation sum C(∈) for small scalar ∈ may be defined in accordance with the following function.

$$C ( ϵ ) = {lim}_{N \to ∞} \frac{2}{N ( N - 1 )} {\sum }_{i < j} H ( ϵ - \vert {x}_{i} - {x}_{j} \vert ) \qquad ( 20 )$$

H may represent the Heaviside step function. N may represent the number of points. |xᵢ−x| may represent the distance between two points.

FIG. 9 displays the outcomes of a correlation dimension (D₂) analysis across various datasets. The correlation dimension gauges chaotic tendencies, with higher values suggesting heightened chaos. This assessment involves different state numbers: 50, 100, 500, and 1000 and it exhibits D₂ values for each dataset and state number. The findings reveal that, for all datasets, the correlation dimension increases with higher state numbers, indicating intensified chaotic behavior. Since Mackey Glass Series (MGS), Electrocardiogram Signal (ECG), and Lorenz Attractor datasets are highly chaotic datasets, they showed the higher D₂.

The following provides a description related to various ablation study.

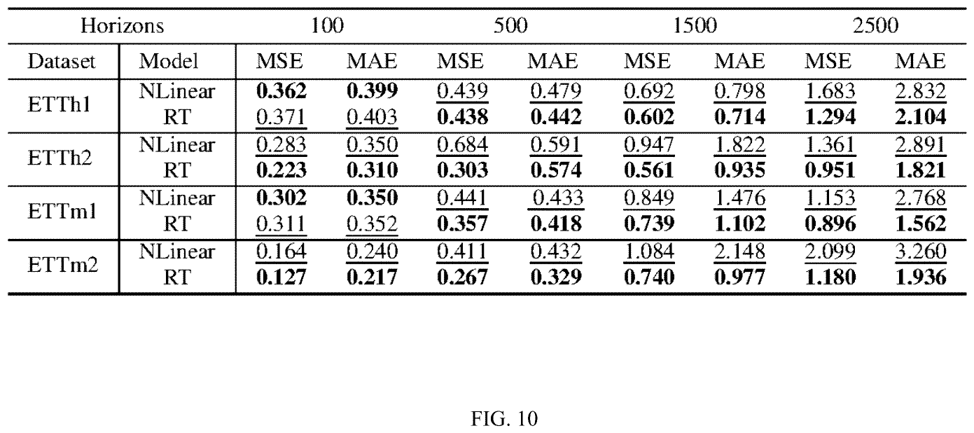

Regarding Lyapunov Exponent (LE), the LE measures how chaotic a system is by computing how quickly points on a path move away from each other over time. FIG. 10 illustrates the reservoir transformer and a baseline NLinear LE over different time steps of 100, 500, 1500, and 2500, in future on different datasets (ETTh1, ETTh2, ETTm1, ETTm2) and outperforms the NLinear model in predicting the LE.

In particular, FIG. 10 illustrates a comparison of NLinear and reservoir transformer for explaining the Lyapunov Exponent's predictive performance across different datasets. The table presents MSE and MAE values for both models at various prediction horizons: 100, 500, 1500, and 2500. The results demonstrate that the reservoir transformer consistently outperforms the NLinear model, achieving significantly lower MSE and MAE values, thus overcoming the Lyapunov Exponent's challenges of far-sighted forecasting.

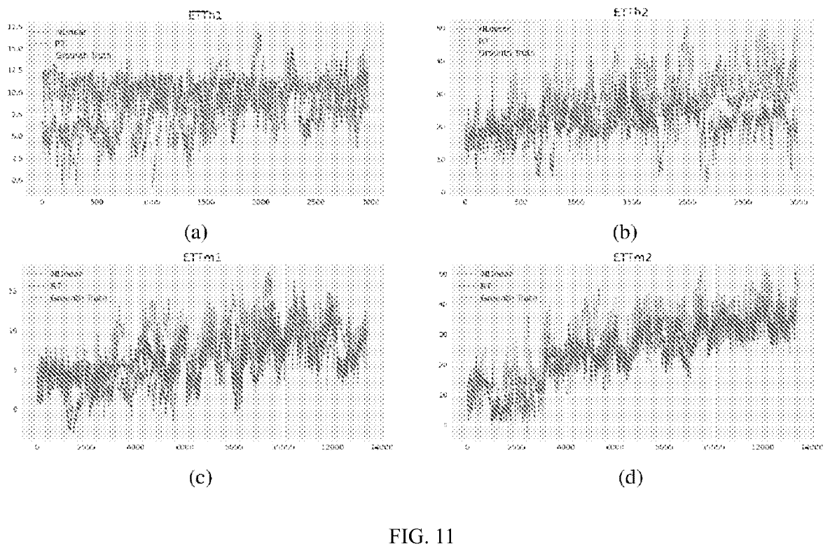

FIG. 11 illustrates a visualization comparing the prediction of the Lyapunov Exponent using NLinear and reservoir transformer. The X-axis corresponds to the time sequence, while the Y-axis corresponds to the target feature. Here, FIG. 11 shows the comparison of forecasting 2500 future time steps between the NLinear and reservoir transformer, where reservoir transformer matches more the ground truth than NLinear.

Regarding signature features, how well-distributed the features input of transformer with or without reservoir is measured. More distribution means higher entropy and more informative, and vice versa. The Local Interpretable Model-agnostic Explanations (LIME) algorithm is utilized with the goal of explaining the decision-making process within the readout layer by employing LIME to generate a local linear approximation of the model.

The initial step involves generating perturbed input time series by adding noise to the original \vec{u}(t). A simpler interpretable model is then trained using these perturbed inputs along with corresponding output time series \vec{y}(t). The complexity of the interpretable model depends on the reservoir model's intricacy, encompassing both linear and non-linear options. Ultimately, the coefficients of the interpretable model is utilized, along with LIME-calculated feature importances, to explain the readout layer's decision.

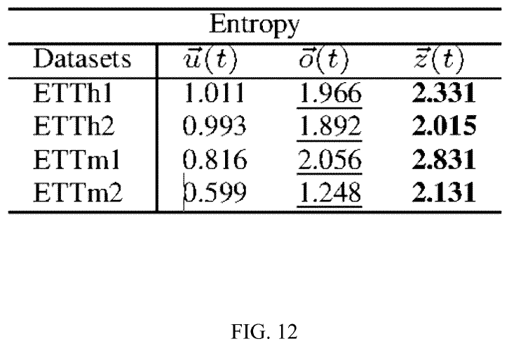

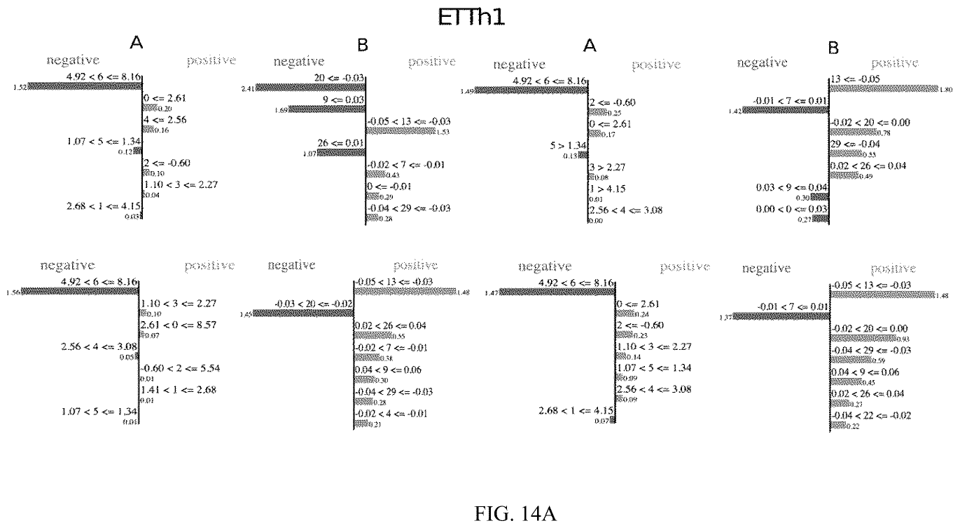

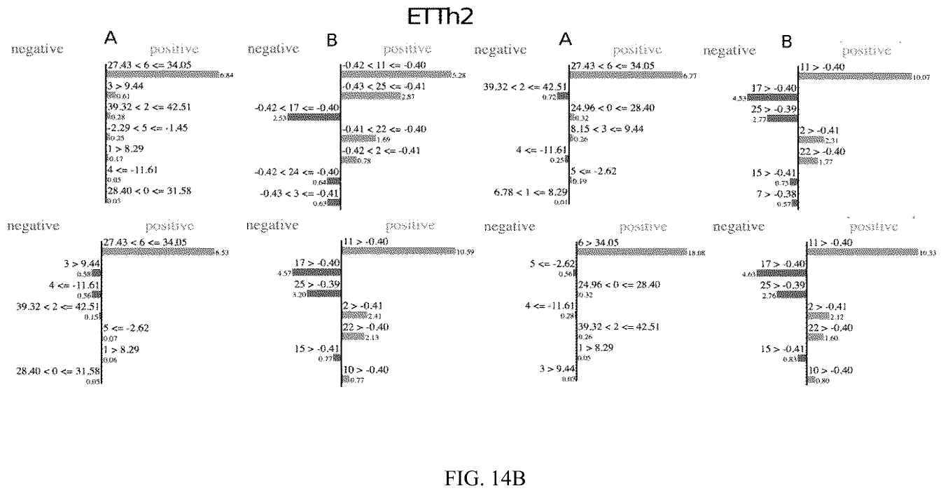

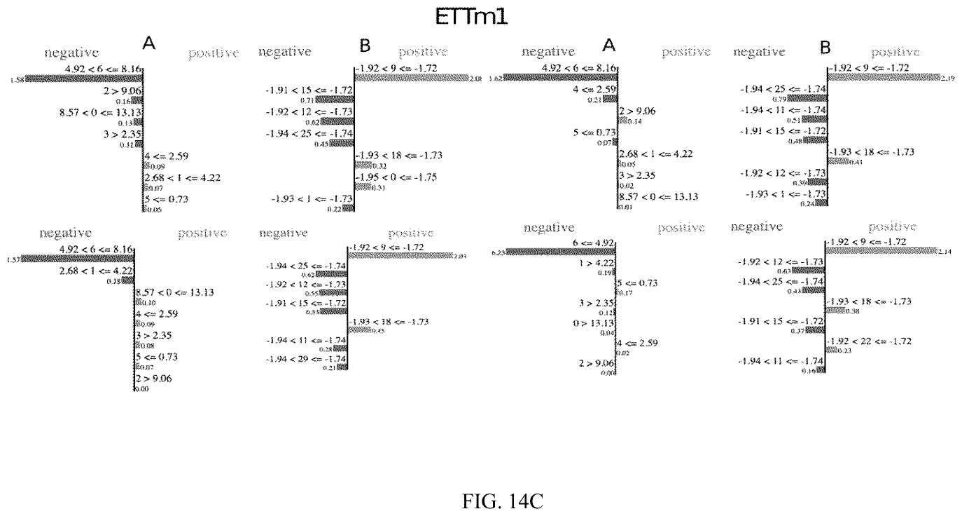

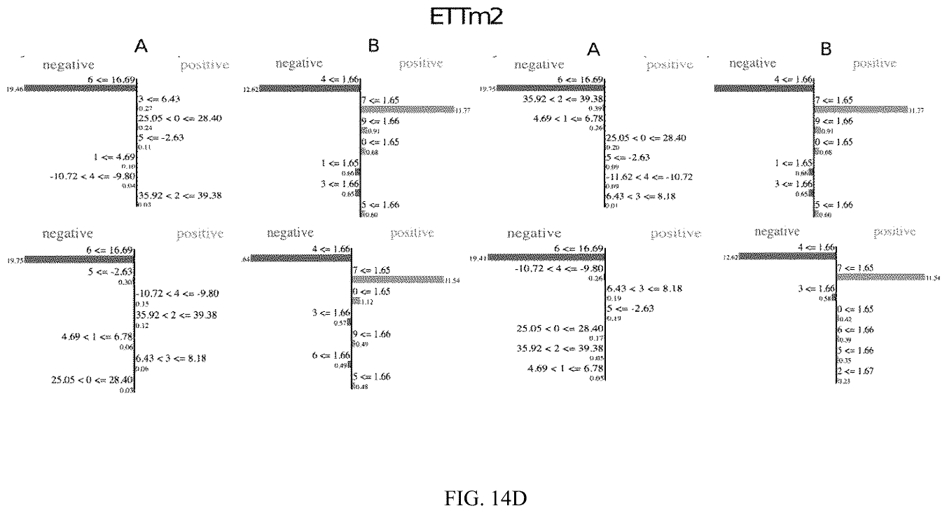

FIG. 14 illustrates entropy in different datasets. The table shown in FIG. 12 presents the entropy values of the original inputs \vec{u}(t), the corresponding reservoir readouts \vec{o}(t) and the resultant transformed representations \vec{z}(t) across various datasets. Here, FIG. 12 shows that the readout from the reservoir \vec{o}(t) has higher entropy than transformer original input features \vec{u}(t). By concatenating both using equation 10, the highest entropy is achieved.

Regarding history length versus parameter size. The conventional approaches for modeling temporal data require a large number of training parameters, proportional to the window size (s) and the number of features (C). This becomes infeasible when considering long historical sequences. In contrast, reservoir computing approaches, such as the example embodiments described in relation to method 100, only train a vector representation (i.e. readout) for the next time step without explicit conditioning on the entire history.

Regarding impact of reservoir initial conditions. In the experiment, the intricate dynamics of reservoir initialization and its consequential impact on the performance of the reservoir transformer of example embodiments of the present disclosure is analyzed. The reservoir initialization process lays the foundation for the system's dynamic behavior, influencing the trajectory of internal states and subsequent information processing capabilities. The impact of different initialization conditions on the performance of the reservoir transformer is investigated. Five distinct initialization approaches are employed, both in ensemble configurations with group reservoirs and without group reservoirs.

Firstly, random initialization is utilized, which initializes the reservoir randomly within the range of 0 to 1. Subsequently, zero initialization is employed, which sets all reservoir values to zero. Constant initialization is also explored, where a constant value is randomly selected for initialization. Further, initialization using normal and uniform distributions is also investigated. The experimentation revealed that among these initialization methods, zero initialization consistently yielded superior results in terms of MSE loss, both in ensemble setups with and without group reservoirs. Notably, the ensemble technique with group reservoirs demonstrated the lowest loss across both the ETTh2 and ETTm2 datasets.

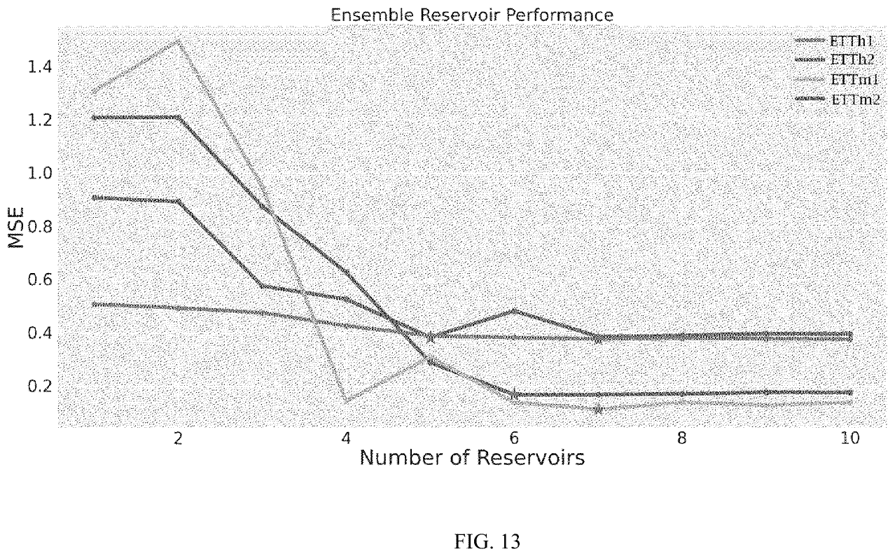

Regarding impact of reservoir count on performance. FIG. 13 illustrates a relationship between the number of the ensemble reservoirs and system performance. The X-axis depicts the count of reservoirs in the ensemble, while the Y-axis portrays the Mean Squared Error (MSE) value of the predicted output. The graph discernibly demonstrates that increasing the number of reservoirs positively correlates with performance enhancement, leading to a reduction in loss. However, beyond a certain threshold of reservoir count (best hyperparameters of the number of reservoirs), the performance improvement saturates, resulting in a plateau in loss reduction. This phenomenon suggests an optimal range for reservoir count in relation to performance enhancement. It is noted that the star shown in FIG. 13 denotes the minimum MSE achieved.

FIG. 14A to FIG. 14D illustrate a LIME explanation effect of current input (A) and reservoir (B) on output prediction. The test dataset is represented by ETTh1, ETTh2, ETTm1, and ETTm2. The results indicate that current input has a greater impact on feature 6, while the reservoir affects multiple features such as 20, 13, 29, and 7. FIG. 14A to FIG. 14D offer a comprehensive insight into the interpretability of features derived from both the reservoir output \vec{o}(t) and input feature \vec{u}(t).

Regarding dataset and parameter configuration. The following outline the approach taken for dataset partitioning and parameter selection performed.

The dataset is divided sequentially into three distinct sets: a training set, a validation set, and a test set. Specifically, the first 70% of the data is assigned to the training set, while 10% is allocated to the validation set, and the remaining 20% forms the test set. This partitioning strategy enables effective model training, validation, and evaluation. The configuration of model parameters plays a crucial role in our research methodology. For the transformer architecture, four Transformer blocks are employed, each comprising 32 multi-head attention mechanisms with a total of four attentions. In the case of the Feedforward Neural Network (FNN), hidden layers containing 64 units each are utilized.

Within the network architecture, dropout is employed as a regularization technique. Specifically, a dropout rate of 0.4 is applied to the hidden layers, while a rate of 0.1 is used for the reservoir network. Additionally, dropout with a rate of 0.2 is integrated into the attention network. Furthermore, the reservoir state size varies between 20 and 50 units across different ensemble reservoirs. To introduce diversity in the ensemble process, sparsity levels range from 0.3 to 0.7 for different reservoirs, accompanied by leaky units with values ranging from 0.2 to 0.6, are utilized. Finally, a learning rate of 1×10⁻⁴ is adopted to facilitate the training process and achieve optimal convergence. By meticulously configuring these parameters, a comprehensive understanding of the model's performance across various experimental setups is attained.

In this regard, in order to analyze the performance and evaluation of the example embodiments of the present disclosure, Mean Squared Error (MSE), and Mean Absolute Error (MAE) have been used for regression. The MSE is a quantification of the mean squared difference between the actual and predicted values. The minimum difference, the better the model's performance. On the other hand, MAE is a quantification of the mean difference between the actual and predicted values. Similar to MSE, the minimum score of MAE, the better the model's performance. For classification tasks, Accuracy and E1 score metrics are utilized.

The descriptions for various datasets are provided herein.

The Electricity Transformer Temperature hourly-level (ETTh) dataset presents a comprehensive collection of transformer temperature and load data, recorded at an hourly granularity, covering the period from July 2016 to July 2018. The dataset has been meticulously organized to encompass hourly measurements of seven vital attributes related to oil and load characteristics for electricity transformers. These incorporated features provide a valuable resource for researchers to glean insights into the temporal behavior of transformers. For the ETTh1 subset of the dataset, the architecture of the example embodiments of the present disclosure entails the utilization of reservoir units ranging in size from 20 to 50, coupled with an ensemble comprising five distinct reservoirs. The attention mechanism deployed in this context employs a configuration of 15 attention heads, each possessing a dimension of 10 for both query and key components. Likewise, for the ETTh2 subset, the approach involves employing a total of seven ensemble reservoirs, each incorporating reservoir units spanning from 20 to 50 in size. The remaining parameters for this subset remain consistent with the configuration established for ETTh1.

The Electricity Transformer Temperature 15-minute-level (ETTm) dataset offers a heightened level of detail and granularity by capturing measurements at intervals as fine as 15 minutes. Similar to the ETTh dataset, ETTm spans the timeframe from July 2016 to July 2018. This dataset retains the same seven pivotal oil and load attributes for electricity transformers as in the ETTh dataset; however, the key distinction lies in its higher temporal resolution. This heightened level of temporal granularity holds the potential to unveil subtler patterns and intricacies in the behavior of transformers. In the context of model architecture, the configuration adopted for the ETTm dataset involves the use of ensemble reservoirs. Specifically, for the ETTm1 subset, an ensemble of seven reservoirs is employed, while for the ETTm2 subset, an ensemble of six reservoirs is utilized. This distinctive architectural setup is designed to harness the increased temporal resolution of the ETTm dataset, enabling the model to capture and interpret the finer nuances within the transformer data.

The exchange rate dataset includes the daily exchange rates for eight foreign countries: Australia, Britain, Canada, Switzerland, China, Japan, New Zealand, and Singapore. This data ranges from the year 1990 to 2016. To analyze this information, 15 reservoirs are utilized, which are a specific type of model to help us understand and predict changes in these exchange rates.

The air quality (AQI) dataset encompasses a collection of recordings pertaining to various air quality indices, sourced from 437 monitoring stations strategically positioned across 43 cities in China. Specifically, the analysis focuses solely on the PM2.5 pollutant. Notably, previous research efforts in the realm of imputation have concentrated on a truncated rendition of this dataset, which comprises data from 36 sensors. For the investigation, 15 ensemble reservoirs are leveraged as the architectural foundation for this dataset. This ensemble configuration is tailored to the distinctive characteristics and complexities inherent in the AQI data. By deploying this setup, we endeavor to enhance our capacity to effectively address the intricate imputation challenges associated with the AQI dataset.

The daily website visitor (DWV) dataset pertains to daily website visitors and provides a comprehensive record of time series data spanning five years. This dataset encapsulates diverse metrics of traffic associated with statistical forecasting teaching notes. The variables encompass daily counts encompassing page loads, unique visitors, first-time visitors, and returning visitors to an academic teaching notes website. The dataset comprises 2167 rows, covering the timeline from Sep. 14, 2014, to Aug. 19, 2020. From this array of variables, the specific focus centers on the ‘first-time visitors,’ which have been identified as the target variable within the context of a regression problem. By delving into this specific variable, insights regarding the behavior of new visitors to the website and its associated dynamics is uncovered. In terms of the model architecture employed for this dataset, a configuration centered around 12 ensemble reservoirs is constructed. This architectural choice reflects the dataset's intricacies and the requirement for an approach that can effectively capture the underlying patterns and variations within the daily website visitor data.

The daily gold price (DGP) dataset pertains to daily gold prices and offers an extensive collection of time series data encompassing a span of five years. This dataset encapsulates a range of metrics pertaining to gold price dynamics. The variables included cover daily measurements related to various aspects of gold pricing. The dataset consists of 2167 rows, covering the time period from Sep. 14, 2014, to Aug. 19, 2020. The primary objective in the analysis is regression, wherein the aim is to model relationships and predict outcomes based on the available variables. Specifically, the analysis aims to predict the daily gold price based on the given set of features. In terms of the architectural setup for this dataset, a model configuration that employs 10 ensemble reservoirs is established. This choice is rooted in the need to effectively capture the nuances and trends inherent in the daily gold price data. By employing this ensemble-based approach, the model's capacity to discern patterns and fluctuations within the gold price time series is enhanced.

The Daily Demand Forecasting Orders (DDFO) dataset is a regression dataset that was collected during 60 days from a real database of a Brazilian large logistics company. Twelve predictive attributes and a target that is considered a non-urgent order. 17 ensemble reservoirs are used for this dataset.

Bitcoin Historical Dataset (BTC) contains the historical price data of Bitcoin from its inception in 2009 to the present. It includes key metrics such as daily opening and closing prices, trading volumes, and market capitalizations. This comprehensive dataset captures Bitcoin's significant fluctuations and trends, reflecting major milestones and market influences. It serves as an essential tool for analyzing patterns, understanding price behaviors, and predicting future movements in the cryptocurrency market. 10 ensemble reservoirs are used for this dataset.

Absenteeism at Work dataset is sourced from the UCI repository, specifically the “Absenteeism at work” dataset. In the analysis, the dataset has been utilized for classification purposes, specifically targeting the classification of individuals as social drinkers. The dataset comprises 21 attributes and encompasses a total of 740 records. These records pertain to instances where individuals were absent from work, and the data collection spans the period from January 2008 to December 2016. Within the scope of the analysis, the primary objective is classification, wherein the goal is to categorize individuals as either social drinkers or non-social drinkers based on the provided attributes. The architectural arrangement for this dataset involves the utilization of 15 ensemble reservoirs. This choice of model configuration is underpinned by the aim to effectively capture the intricacies inherent in the absenteeism data and its relationship to social drinking behavior. Employing ensemble reservoirs empowers the model to discern nuanced patterns and interactions among the attributes, thereby enhancing its classification accuracy.

Temperature Readings of IoT Devices dataset pertains to temperature reading from IoT devices and centers on the recordings captured by these devices, both inside and outside an undisclosed room (referred to as the admin room). This dataset comprises temperature readings and is characterized by five distinct features. In total, the dataset encompasses 97605 samples. The primary objective in the analysis involves binary classification, where the aim is to classify temperature readings based on whether they originate from an IoT device installed inside the room or outside it. The target column holds the binary class labels indicating the origin of the temperature reading. In terms of dataset characteristics, the architecture of the model involves the utilization of 15 ensemble reservoirs. This architectural choice is rooted in the desire to effectively capture the underlying patterns and distinctions present within the temperature readings dataset. The use of ensemble reservoirs enhances the model's capacity to distinguish between the different temperature reading sources, thereby facilitating accurate classification.

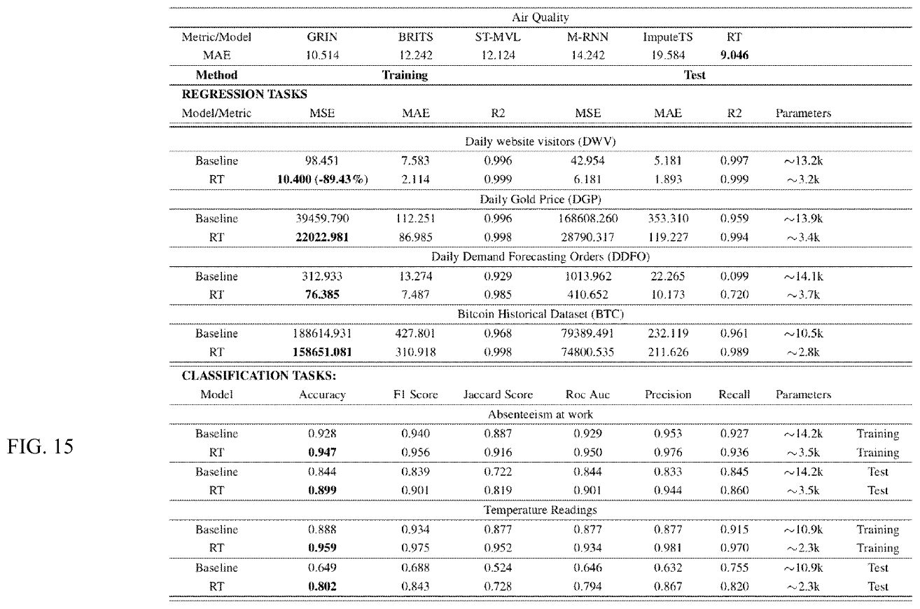

FIG. 15 illustrates performance assessment table on both training and datasets. Here, a window size of s=5 is utilized to observe historical data in baseline transformers. Here, FIG. 15 shows that the reservoir transformer outperforms GRIN, BRITS, STMVL, M-RNN, and ImputeTS on the air quality dataset. On regression and classification tasks, reservoir transformer consistently outperforms the baseline transformer with respect to all criteria, achieving significantly lower MSE and MAE values across various datasets like DWV, DGP, DDFO, and BTC. This suggests that the reservoir transformer is better equipped to capture complex temporal patterns. In the classification tasks, the reservoir transformer demonstrates better performance in terms of accuracy, F1 Score, Jaccard Score, Roc Auc, Precision, and Recall across different datasets like Absenteeism at work and Temperature Readings. Through this analysis, the evidence that the RT architecture excels not only in regression tasks but also in classification tasks, outperforming traditional transformer architectures is provided.

The following provides a description on parameter and performance comparison of reservoir with transformer encoder with transformer, LSTM, CNN by increasing their time steps. Subsequently, the performance and analysis result using real life time series data-sets are discussed. The uni-variate regression, multi-variate regression and classification datasets are used for conducting experiments. It is assumed the first 80% of data are training and the rest 20% data are for testing sequentially. Since all data are sequential data, no shuffling is performed. Besides, to design transformer block, 2 blocks with 2 multi-head attention are used, and 1 kernel of 4 CNN as feed forward of transformer are used. In the second final feed forward neural net, 28 units with 0.4 dropout is used.

Since time series depends on current state and its history, in the training time getting whole history with current state is very important to predict. In order to get the whole history it is necessary to train all t steps and their features n. Then the parameters will be increased by f×n. If a big history with high dimensional features is used the parameters size will be exponential. Since reservoir does not train the history, it only trains a vector representation rᵢ₊₁ of history where γ<<t*v with the concatenation of uₖ and goes as input of transformer encoder.

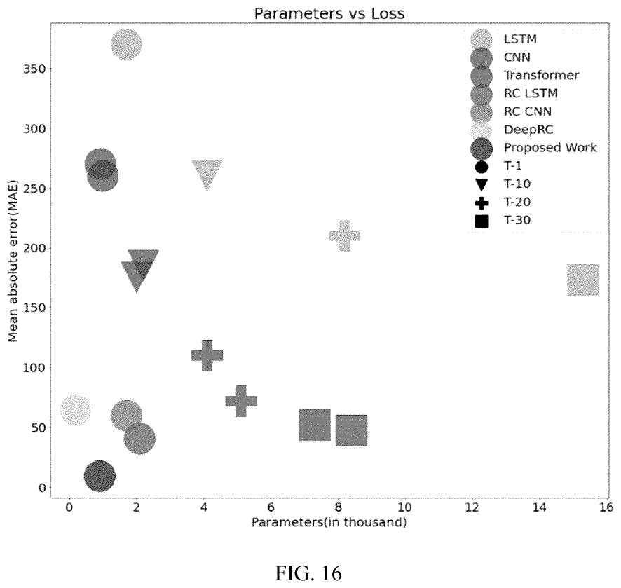

FIG. 16 illustrates a relationship between parameter size and mean absolute error MAE. The X-axis represents the size of parameters in thousand and the Y-axis represents mean absolute error (MAE). T is the time steps. Time steps are proportional to parameter size and much more inverse to MAE. Here, FIG. 16 shows that getting history can predict better target. Reservoir transformer has been shown the better performance in the trade-off training parameters and time history. Besides, deep reservoir shows a good performance but it is not trainable without its readout layer. For CNN, LSTM, and transformer, they showed good performance with high parameters consequently. This experiment has been conducted on synthetic data with v=10 features and t=50 history on 100k samples.

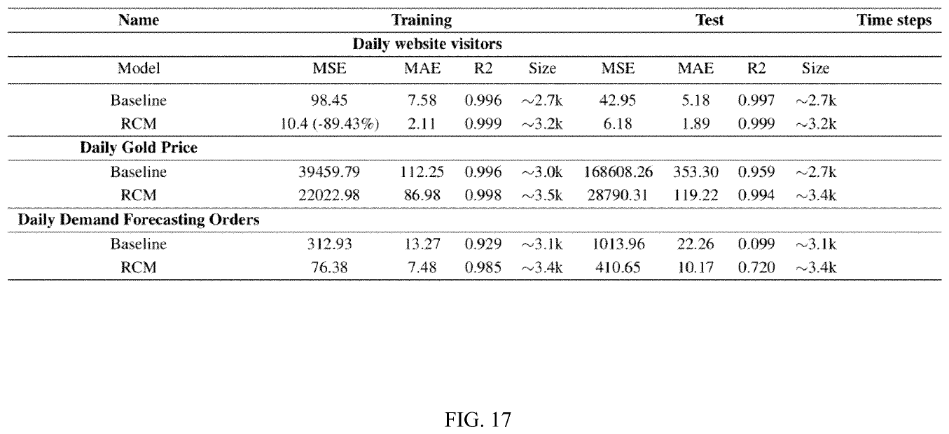

FIG. 17 illustrates a table showing multi-variate time series datasets for regression. As shown in FIG. 17, the multi-variate time series datasets for regression includes daily website visitors, daily gold price, and daily demand forecasting orders.

Daily website visitor dataset contains 5 years of daily time series data for several measures of traffic on a statistical forecasting teaching notes. The variables are daily counts of page loads, unique visitors, first-time visitors, and returning visitors to an academic teaching notes website. There are 2167 rows of data spanning the date range from Sep. 14, 2014, to Aug. 19, 2020. Among the all variables, the ‘first-time visitors’ is considered as target variables and regression problem.

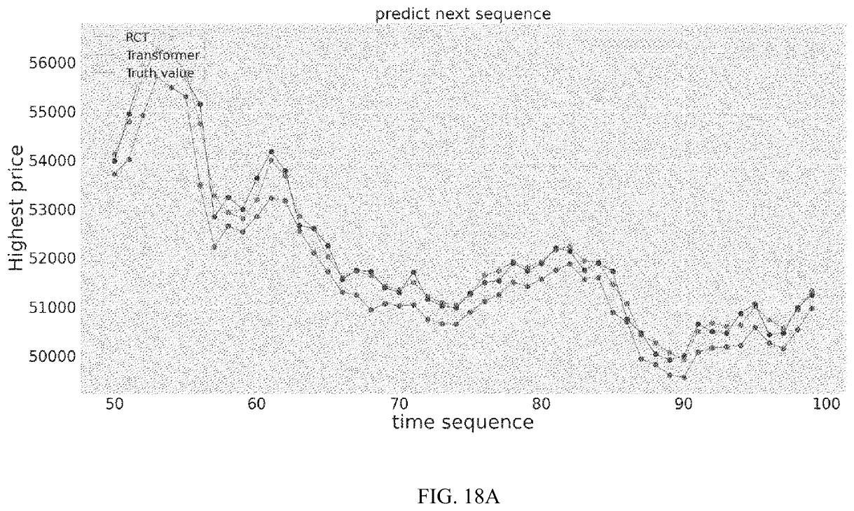

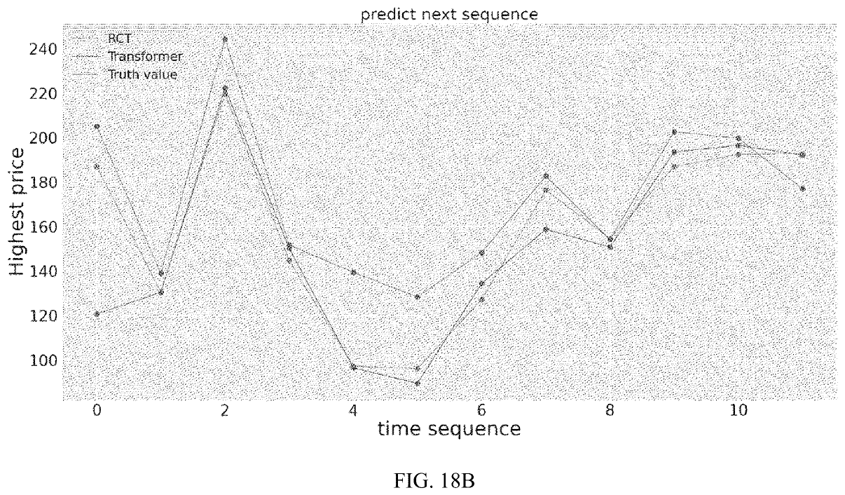

Daily Gold Price dataset contains 5 years of daily time series data for several measures of traffic on a statistical forecasting teaching notes website. The variables are daily counts of page loads, unique visitors, first-time visitors, and returning visitors to an academic teaching notes website. There are 2167 rows of data spanning the date range from Sep. 14, 2014, to Aug. 19, 2020. FIG. 18A illustrates a relationship between the highest price and time sequence for gold price time sequence detection.

Daily Demand Forecasting Order dataset was collected during 60 days from a real database of a Brazilian large logistics company. Twelve predictive attributes and a target that is considered as Non-urgent order. FIG. 18B illustrates a relationship between the highest price and time sequence for daily order time sequence detection.

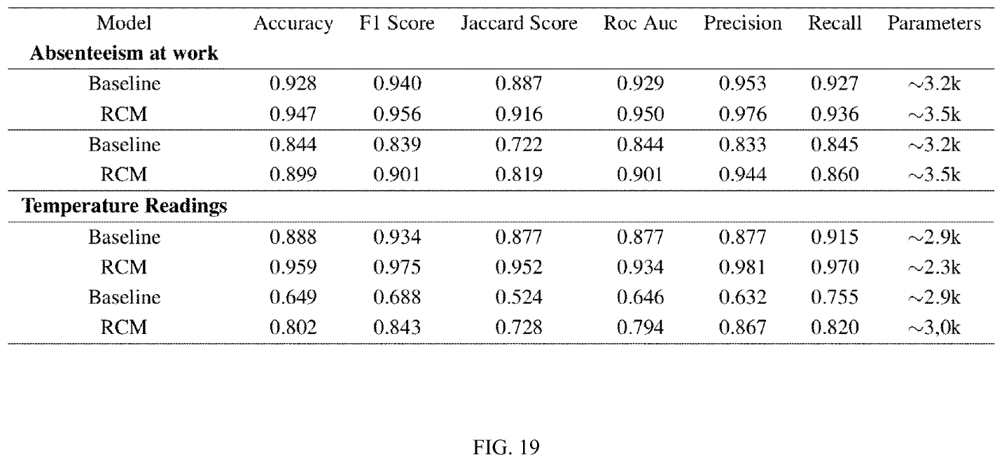

FIG. 19 illustrates a table showing multi-variate time series datasets for classification. As shown in FIG. 19, the multi-variate time series datasets for classification includes absentee at work and temperature readings of IOT devices.

Absentee at Work dataset has been taken from “UCI—Absenteeism at work” and used for classification to classify social drinker. The database used has 21 attributes and 740 records from documents that prove that they are absent from work and was collected from January 2008 to December 2016.

Temperature Readings of IOT Devices dataset contains the temperature readings from IOT devices installed outside and inside of an anonymous Room (e.g., admin room). This dataset has 5 features and 97605 samples. The target column is binary class whether temperature reading was taken from IOT device installed inside or outside of the room.

The implementation of features associated with the linear readout data and the plurality of reservoirs (ensemble reservoirs) to a transformer according to one or more example embodiments described above in relation to method 100 (hereinafter reservoir transformer) consistently outperforms baseline models in multivariate time series, including PatchTST, PatchTsMixer, and standard Transformers, with error reductions up to −65% across various domains such as ETTh, ETTm, BTC, Weather, and air quality, demonstrating strong ability to forecast far-horizon events by incorporating comprehensive memory.

The following provides a description on experimental verification on dataset and parameter configuration.

Reservoir transforpers are evaluated on several datasets commonly used for benchmarking TSF, including four ETT datasets (ETTh1, ETTh2, ETTm1, and ETTm2), Weather, Traffic, Air Quality (AQ), Daily Website Visitors (DWV), and Bitcoin Historical Dataset (BTC). Some datasets are sequentially partitioned into three distinct sets: training (70%), validation (10%), and testing (20%), for training, validation, and testing of models, respectively.

Well-known time-series forecasting models are used for baseline comparisons, including Transformer based systems, PatchTST, Informer, PatchTSMixer, Autoformer, and pre-trained LLMs-based systems such as TimeLLM. Pytorch and Huggingface libraries are used to implement the framework. All experiments were carried out on a single Nvidia RTX-4090 or Tesla H100 GPU.

For the transformer architecture, the PatchTST is employed as the basemodel, with a fixed look-back window k=512. For the Feed-Forward Network (FFN) setting within the PatchTST model, the FFN dimension is set equals to 256. Within the PatchTST network architecture, dropout is employed as a regularization technique. Specifically, a dropout rate of 0.2 is applied to the hidden layers. Furthermore, the reservoir state size varies between 15 and 50 units across different ensemble reservoirs. To introduce diversity in the ensemble reservoirs, spectral radius values range from 0.5 to 0.9 for different reservoirs, accompanied by leaky units with values ranging from 0.2 to 0.6. Finally, a learning rate of 1×10³ is adopted to facilitate the training process and achieve optimal convergence.

Mean Squared Error (MSE), and Mean Absolute Error (MAE) are used to evaluate the proposed work. The MSE is a quantification of the mean squared error measured between the actual and predicted values. On the other hand, MAE is a quantification of the mean error measured between the actual and predicted values. The smaller value of MSE and MAE, the better the model's performance.

FIG. 20 illustrates the time-series forecasting prediction error rate results. The input time series length k is set to 300, and four different prediction horizon h∈{96,192,336,720} are tested. The reservoir transformer consistently outperforms all baselines in most cases, achieving significant error reductions. In particular, FIG. 20 shows multivariate long-term time-series forecasting where lower values indicate better performance. Forecasting horizons are h∈{24, 36, 48, 60} for ILI and h∈{96, 192, 336, 720} for the rest.

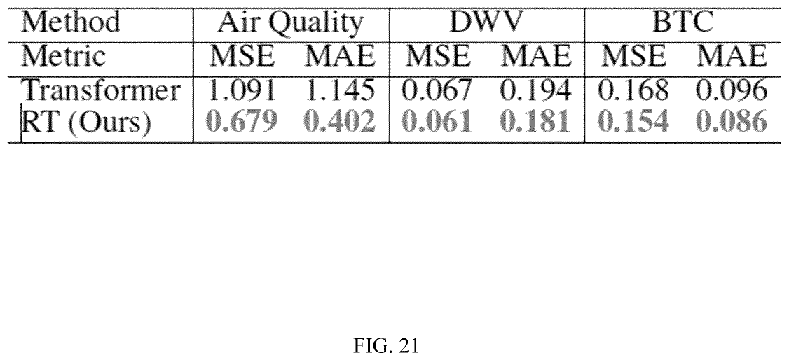

FIG. 21 illustrates time series comparison in MSE, MAE, Accuracy, and F-score with reservoir transformer and baseline transformer. ‘Acc.’ is the Accuracy. Here, FIG. 21 shows that the reservoir transformer model of example embodiments of the present disclosure significantly outperforms baseline Transformer on Air Quality (AQ), Daily Website Visitors (DWV), and Bitcoin Historical Dataset (BTC). Notably, the reservoir transformer model method achieves a deduction of MAE on the air quality dataset from 1.145 to 0.402, i.e., −65% relatively.

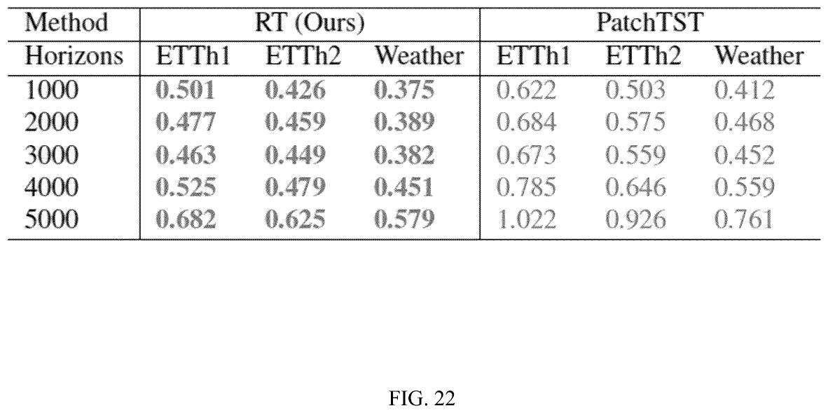

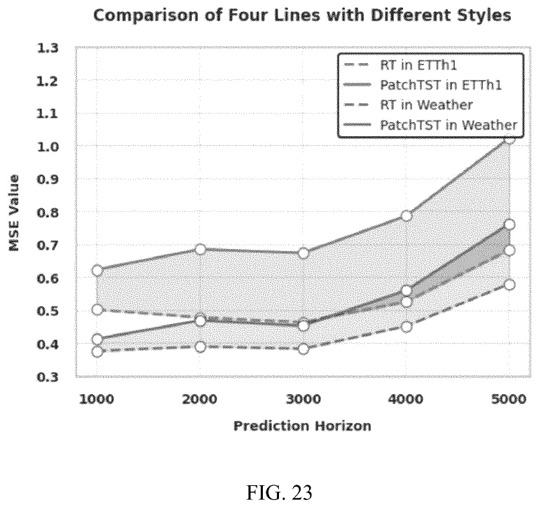

FIG. 22 illustrates MSE on three typical datasets, and FIG. 23 illustrates MSE versus horizon length. FIG. 22 and FIG. 23 here show that the reservoir transformer model of example embodiments of the present disclosure demonstrates greater improvement over long horizon tasks.

The following provides a description on ablation analysis.

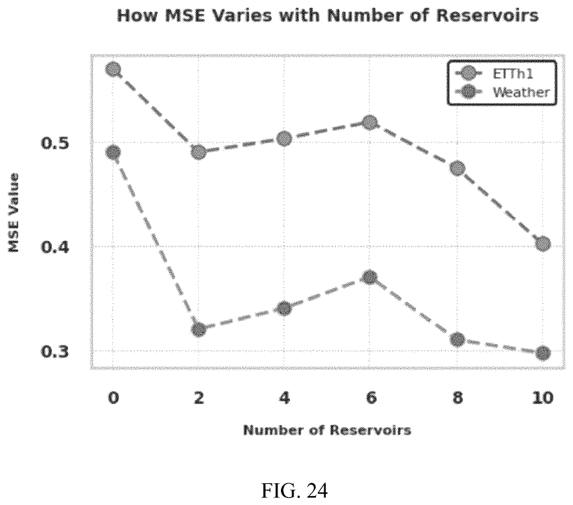

FIG. 24 illustrates a relationship between the number reservoirs in the ensemble reservoir and system performance. Increasing the number of reservoirs improves the performance, leading to a reduction in loss until the loss converges at 10 reservoirs. The upper line corresponds to ETTh1, while the lower line corresponds to Weather.

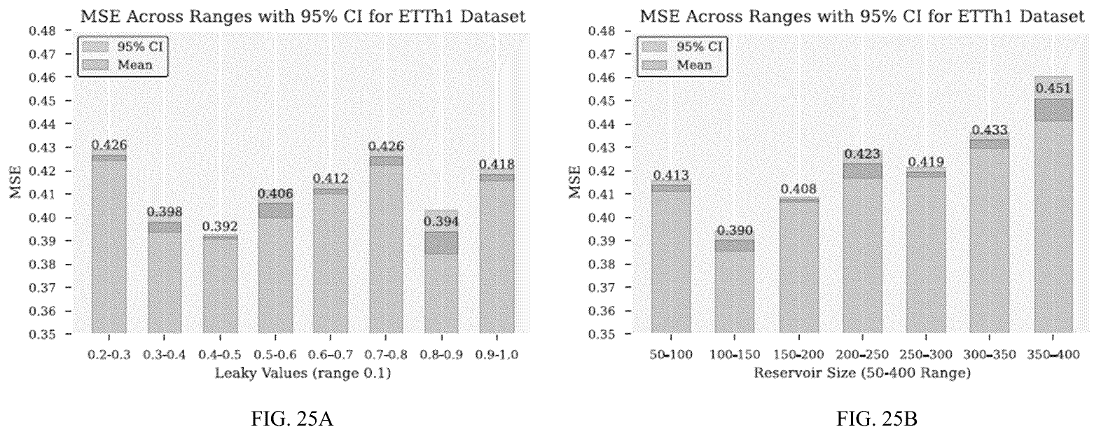

FIG. 25A to FIG. 25B illustrate the effect of Leaky values and reservoir size on the reservoir transformer model. In particular, FIG. 25A shows the effect of Leaky Values on the model performance, while FIG. 25B shows the effect of reservoir size on the model performance For the reservoir size ablation study, 10 different reservoirs are used to capture a range of 50 reservoir sizes and further analyze how this range would affect the model performance, e.g. for the reservoir transformer model with 10 reservoirs, the size for each reservoir is set to be [50, 55, 60, . . . , 90, 95] in order to have a general understanding of how reservoir size in range from 50 to 100 performs. In addition, for the study of leaky value ablation, a similar model is also used to pick which leaky value range would yield the best results, with the 0.1 range length. In summary, the best hyperparameter setting that is recommend is (100-150) for reservoir size and (0.5-0.6) for leaky value settings.

The experiments to compare the performance of reservoir transformer with or without the Embedding layer are also conducted. Taking the ETTh1 dataset as an example, without using the Embedding layer (∈), the MSE obtained for 720 prediction horizon is 0.623, however, after applying the Embedding layer, the MSE decreases about 38%, reaching 0.391.

In order to effectively combine the reservoir outputs with the embedded input, two combination methods are attempted, concatenation and cross-attention. Both methods are attempted on the ETTh1 dataset, and found the MSE for the Cross-attention method is 0.391 while the MSE for the Concatenation is about 0.82, which is much worse than the cross-attention method, one explanation for this phenomena is the imbalance size between the reservoir outputs and the embedded inputs.

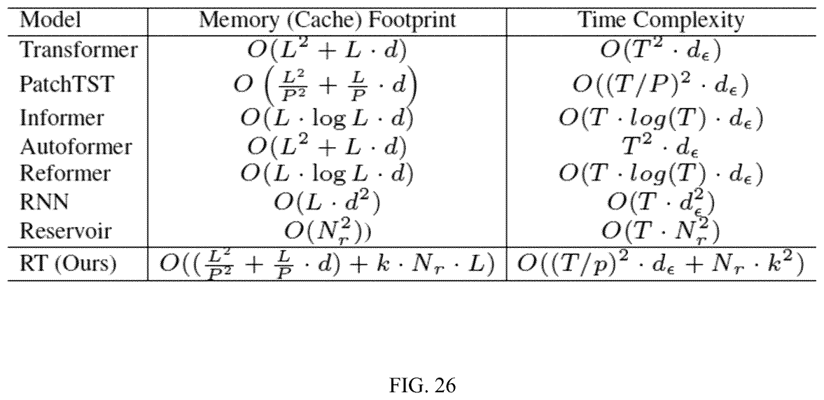

FIG. 26 illustrates the memory (cache) footprint and time complexity of different models. The notations are as follows. Nᵣ is the reservoir states output dimension; L is the number of reservoirs in the group (ensemble) reservoir; k is the short-term context window length; T is the long-term context total input length; ly is the number oflayers; H is the number of attention heads; c is the Compressive Transformer memory size; r is the compression ratio; p is the number of soft-prompt summary vectors; v is the summary vector accumulation steps; s is the kernel size; P is the patch size; d_{∈} is the embedding model dimension; dk is the dimension of keys in attention; and dᵥ is the dimension of values in attention.

The reservoir transformer methods are compared with several other baseline models on the time complexity and memory footprint, including PatchTST which reduces sequence length via patches, significantly lowering complexity; Informer which uses ProbSparse self-attention, suitable for long sequences; Autoformer which introduces auto-correlation mechanism, but the attention remains O(L²); Reformer which uses LSH to reduce attention computation complexity; and RNN model which computes multi-variants time series step by-step, holding low complexity but struggles with long range dependencies. Since PatchTST is used as the basemodel, the memory complexity and time complexity of the reservoir transformer is O((T/p)²·d_{∈}+Nᵣ+k²) and O((T/p)²·d_{∈}+L·T²) which looks similar with other Transformer-based model with additional memory and time required for tracking, computing and using reservoir states.

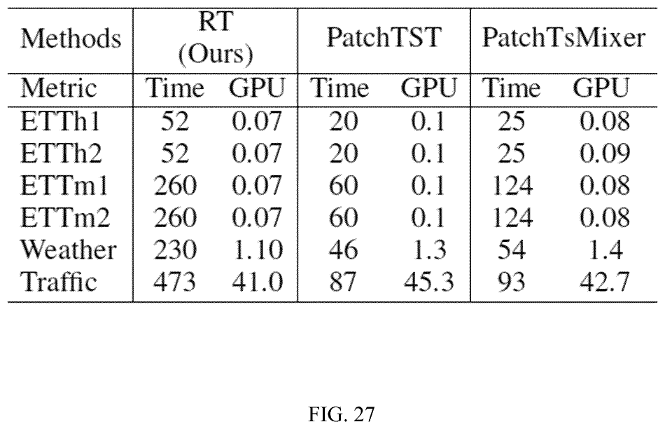

FIG. 27 illustrates a comparison of the memory usage and training time of the reservoir transformer method with other approaches. In particular, FIG. 27 shows per-epoch time (seconds, s) and GPU usage (GB) for reservoir transformer, PatchTST, and PatchTsMixer on different datasets. Despite being based on PatchTST, the reservoir transformer method uses less memory and requires a reasonable training time in comparison to the baselines.

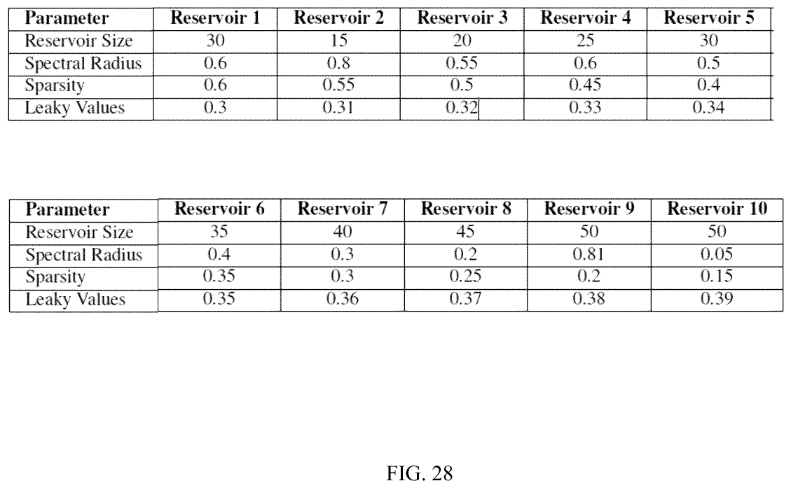

FIG. 28 illustrates a list of reservoir settings for all 10 different reservoirs.

Researchers have compared different types of reservoir networks on time-series tasks, including timeseries kernels, feed-forward networks, and RNN models. However, the reservoir network with a fixed size fails to effectively handle long context thus underperforms the Transformer-based models. The reservoir computing is introduced to Transformer to solve the input length problem. Previously, solutions have involved interspersing the reservoir layers into the regular Transformer layers that shows improvements in the training efficiency. However, such integration will reduce the feature extraction power of both reservoirs in the long sequences and Transformer in short sequences. Here, the reservoir and Transformer are combined in a way by taking advantage of reservoir's linear operating time to handle all-time history and Transformer's accuracy to learn from short-time memory.

Time-series prediction using machine learning approaches has been investigated in the last decade using CNN, WNN, FNN, LSTM, etc. and other various methods. Recently, Transformer-based solutions have shown success for longterm time series forecasting (LTSF). Nonetheless, Transformer is expensive in terms of quadratic time and space complexity of the input length. Important works have been proposed in improving Transformer architectures and their complexity in long context in various ways including PatchTST, TiDE, FiLM, PRformer, etc. however, compressing the long input sequence into fixed length often misses the dependency of the temporal events.

Researchers have also shown how using pre-trained LLMs for time-series data improves performance compared to training from scratch. However, LLM based time-series forecasting are usually time consuming in training.

Additionally, there has been research on using ensemble of models for time-series prediction. Researchers have proposed ensemble methods that combine multiple hybrid models using wavelet transform and combine multiple deep-learning models and showed improved performance on several datasets. In the example embodiments of the present disclosure, a method to ensemble multiple reservoir networks and form group reservoirs for reliable prediction outputs is described.

Other types of time series prediction models include applying signal processing techniques, such as FEDformer, D-PAD, and Autoformer. These methods still underperform PatchTST, and reservoirs have shown to improve PatchTST's performance here as described above.

According to example embodiments, the above described operations in method 100 may be implemented in the context of language classification.

In particular, accuracy of emotion detection in language classification greatly relies on the effective modeling of contextual information. Transformer-based models, despite achieving state-of-the-art performance, have inherent limitations due to quadratic time and memory complexity, restricting their input length as described above. In this regard the above described operations in method 100 utilizing ensemble reservoirs with non-linear readout data, echo transformer, and cross-attention mechanism may overcome one or more limitations associated with the use of transformer based models for language classification.

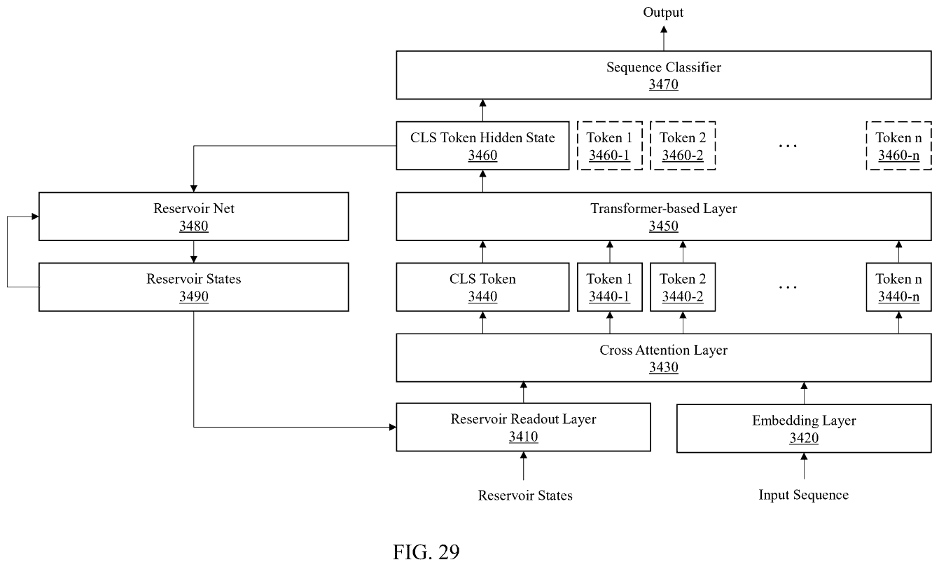

FIG. 29 illustrates an Echo Transformer architecture, according to one or more example embodiments. The Echo Transformer architecture consists of two cascaded modules tailored to handle different context lengths, namely echo state network (ESN) reservoirs and transformers.

For longer contexts, an ESN module (ESN reservoirs) may model the entire context relevant to the current utterance, drawing from all available training corpora. For example, in a script containing multiple seasons and episodes, the ESN module may learn the emotion of a character based on the current sentence within the larger context throughout the TV series (i.e., scripts of all seasons and episodes). In scenarios where the corpus consists of several unrelated books, each book may be learned in its entirety, with the ESN module re-initialized randomly at the beginning of each book's first sentence.

For shorter contexts, a Transformer-based module may capture token-level dependencies within individual sentences. Each sentence may be initially processed by the Transformer-based model to encode within-sentence dependencies, generating sentence embeddings subsequently combined with outputs from the ESN module. The ESN module may read sentence after sentence in their embedded forms and then update the ESN states on all the context of a corpus without training.

This combined representation may be fed into a neural network block. Transformer model may be utilized here, although it is understood that the neural network block may be of any architecture. The CLS token's hidden state is applied to incorporate the sentence level information, enabling comprehensive contextual dependency modeling. This cascaded approach effectively models both long-term dependencies and conventional token-level relationships.

The Echo Transformer architecture may also integrate two distinct memory modules to capture information across different levels of context, short term memory (STM) module and long term memory (LTM) module. The STM module may focus on local dependencies within individual sentences, while the LTM module may process the entire context, allowing it to capture extended dependencies across all previous input sentences in a corpus. The STM may be implemented as Transformer, while the LTM may be implemented as the ESN. The two memory modules work in tandem to model dependencies at multiple scales when the context length grows. Together, these modules enable the model to efficiently manage and utilize context across both global and local levels.

Returning to FIG. 29, the input sequences may correspond to a sequence of sentences which may represent a text form of a corpus, such as books, a series of conversations, episodes and seasons of a TV-series, and the like. The input sequence (sequence of sentences) may be defined in the similar manner as u(t) with t E T, described above, where T here may represent the total number of sentences in the corpus. Further, each input in the input sequence (each individual sentence in the sequence of sentences) may be defined as \vec{w}(j) with j∈J, where J may represent the sentence length. A training dataset can be composed of one or multiple corpora.

In a textual sequence classification task, such as emotion and intent detection, the goal may be to predict the best class \vec{s}(t+1) for the sentence \vec{u}(t+1) based on all previous relevant sentences from \vec{u}(t), which may be defined according to the following function.

$$\vec{s} ( t + 1 ) = arg max Pr ( s \vert \vec{u} ( t ) , \vec{u} ( t + 1 ) ) \qquad ( 21 )$$

The input sequence may be embedded by the embedding layer 3420 as input to obtain sentence embedding matrix as output, in accordance with the following function.

$$ϵ ( u ) = ϵ ( w ( 1 ) ) + ϵ ( w ( 2 ) ) + … + ϵ ( w ( J ) ) + ϵ ( w ( CLS ) ) \qquad ( 22 )$$

∈(w(j)) may represent the embedding layer output for the token w(j) from the transformer last hidden layer in the previous iteration. Further, since the sequence classification NLP tasks is under focus, a CLS token w(CLS) may be added to the embedding process. Here, the notation (+) may indicate element wise addition.

Here, the LTM module may obtain all input sequences of a corpus and outputs a fixed ESN state. The ESN state may be obtained in the similar manner as described above in equation (1) for \vec{x}(t).

Once the ESN state is obtained, the reservoir readout layer may combine the outputs of all ESN units. This involves obtaining a plurality of non-linear readout data according to the following functions.

$$r ( t ) = σ ( {\vec{W}}_{out} \vec{x} ( t ) + {θ}_{out} ) \qquad ( 23 )$$

r(t) may represent the non-linear readout data, and may be defined according to r(t)∈R^{m}, where m may represent the dimensionality. \vec{W}ₒᵤₜ may represent the reservoir-to-readout weight matrix connecting the reservoir units to the units in the readouts, and may be defined according to \vec{W}ₒᵤₜ∈R^{m×N}^{ᵣ}, with Nᵣ representing a number of ESN (hidden) units. θₒᵤₜ may represent the bias-to-readout weight vector, and may be defined according to θₒᵤₜ∈R^{m}. σ may represent the ReLU activation function.

Subsequently, the plurality of readout data may be combined to form an ensemble reservoir data, in the similar manner as described above for equation (8).

Once the ensemble reservoir data is obtained from the LTM module, the cross attention later 3430 may combine the ensemble reservoir data with the embedding layer output, according to the following formula.

$$K = ( \frac{( ϵ ( \vec{u} ( t + 1 ) ) {\vec{W}}_{Q} ) {( \vec{o} ( t ) {\vec{W}}_{K} )}^{T}}{\sqrt{{q}_{k}}} ) \qquad ( 24 )$$

$$ϵ ( \vec{u} ( t + 1 ) ∀ \vec{o} ( t ) = F ( soft max ( K \cdot ( \vec{o} ( t ) {\vec{W}}_{V} ) ) + \vec{o} ( t ) ) \qquad ( 25 )$$

∀ may denote the cross attention operation between the ensemble reservoir data \vec{o}(t) and the embedding layer output ∈(\vec{u}(t+1). qₖ may represent the dimension of keys in the cross-attention. \vec{W}_{Q} may represent queries weight. \vec{W}_{K} may represent keys weights. \vec{W}_{V} may represent values weights. \vec{W}_{Q}, \vec{W}_{K}, and \vec{W}_{V} may be learnable, and may be initialized randomly. F may represent the layer norm of the feedforward neural networks with two layers of linear transformation with 768 neurons, and one layer of ReLU function in between.

The cross attention between the ensemble reservoir data and the embedding layer output is then provided to the Transformer-based layer 3430 to implement STM. It is noted that the input to the STM may include embeddings, which may be initialized using ModernBERT with positional embeddings. Subsequently, the concatenated embeddings and LTM output from equation (25) may be fed into the STM to perform the prediction task, according to the following formula.

$$\overline{\vec{y}} ( t + 1 ) = M ( ϵ ( \vec{u} ( t + 1 ) ∀ \vec{o} ( t ) ) \qquad ( 26 )$$

\vec{y̅}ᵢ(t+1) may represent the predicted output data. M( ) may represent the encoder function of the transformer. \vec{z}(t+1) may represent transformer input obtained above.

The transformer may then be trained based on a loss function (objective), such as cross-entropy loss function, in the similar manner as described above in relation to equation (14). Here, training models with integrated ESN may process the whole dataset sequentially to learn the inherent memory dependency between samples. Traditional batch training is impractical as each sample's computation is contingent on its predecessor. Therefore, a batch training may be performed to accelerate the training process.

In this regard, in certain implementation, the Echo Transformer architecture may not support the typical Transformer parallelization because the ESN processes input sentence by sentence to update its internal states. Critically, the update for the next sentence may depend on the ESN states generated from the previous one. Therefore, a new parallelization method may be introduced specifically designed for the Echo Transformer architecture of the example embodiments of the present disclosure.

According to example embodiments, the parallelization method may include the following steps.

Several sentences may be processed in a batch. Each sentence may first be embedded using the ModernBERT embedding layers. These embeddings may then combined with the ESN state output using the V operation, in the similar manner as described above in relation to equation (23). The resulting combined representations may be fed into the STM, which may produce the final-layer hidden states for each sentence in the batch. These hidden states may be subsequently passed to the ESN sequentially, in sentence order, to update its internal state and generate a single output ESN state. This ESN output may then be used as part of the input for the next batch of sentences, continuing the sequential state update.

As an example, if the batch size is set to 4, four sentences may be embedded and combined (∀) with the echo state output from the previous batch's last sentence. These 4 combined inputs may be passed to the STM in parallel, and the resulting 4 hidden states may then be sequentially processed by the ESN to produce one new echo state. This echo state may then be used with the next batch of four sentences. Note that at the beginning of each new corpus, the ESN states may be randomly initialized and learned from scratch.

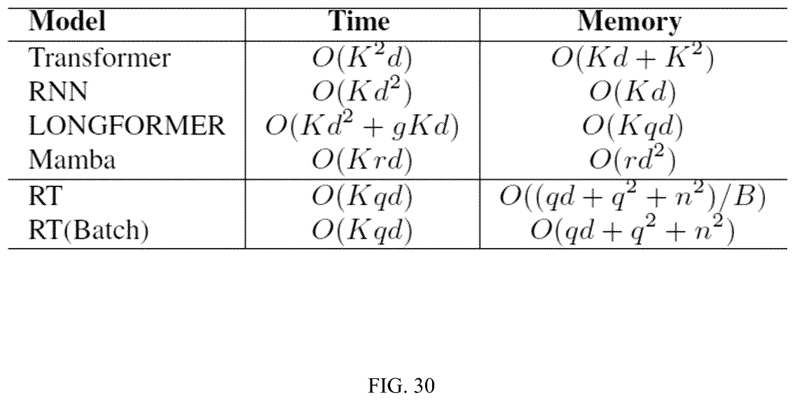

FIG. 30 illustrates a comparison between the Echo Transformer architecture of the example embodiments of the present disclosure with other popular models. Here, K may represent the input sequence length, q may represent the sentence length (or window size in the case of LONGFORMER), g may represent the number of tokens used for global attention, r may represent the rank in the low-rank projection of the state space for the MAMBA model, d may represent the hidden dimension for each model, B may represent the batch size, and n may represent the number of neurons in the Echo State Network (ESN). Conventional Transformers may have a time complexity of O(K²×d),which may become impractical to compute as the input length K grows large due to the quadratic complexity. In contrast, the Echo Transformer architecture of the example embodiments of the present disclosure may separate processing into short term memory (STM) and long term memory (LTM). The LTM component may have linear time complexity O(K) with respect to input length, while the STM may have complexity O(I²d), where I may represent the sentence length. Importantly, I may be set as a constant, allowing the Echo Transformer architecture of the example embodiments of the present disclosure to scale efficiently with increasing input size.

Here, it is noted that the above described processes and operations associated with the Echo Transformer architecture may be part of one or more operations in method 100 described above.

In view of the above, the Echo Transformer architecture of the example embodiments of the present disclosure enables the Transformer architecture to process an unlimited number of input tokens. More specifically, the Echo Transformer architecture may be capable of theoretically handling arbitrarily long inputs with linear time complexity. The cascaded learning framework may enable effective management of long and short contextual information separately. The non-linear readout mechanism leveraging cross-attention may significantly enhance the performance of Echo State Networks (ESNs). The group ESN approach may further improve the effectiveness of the Echo Transformer architecture. The method may be empirically validated, demonstrating notable performance improvements on emotion and intent detection tasks.

Experiments demonstrate that the Echo Transformer architecture of the example embodiments of the present disclosure significantly enhances performance on NLP classification tasks. Specifically, an accuracy increase of +19.9% is observed over ModernBERT and +22.3% over DeepSeek-Qwen-1.5B on the EmoryNLP dataset, and up to +8.58%, +8.00%, and +14.6% over ModernBERT, DeepSeek, and Longformer on the MELD dataset, respectively, in addition to the consistent improvements on MultiWOZ 2.2 and IEMOCAP.

The following provide a description on the experiments carried out to evaluate the Echo Transformer architecture of the example embodiments of the present disclosure as well as the obtained results. Specifically, the goal is to verify that the Echo Transformer architecture of the example embodiments of the present disclosure can handle context of any length taking full context into account.

For data and preprocessing, results are presented on four sequence classification datasets: Multimodal EmotionLines Dataset (MELD), Multi-DomainWizard-of-Oz (MultiWOZ 2.2), EmoryNLP, and the IEMOCAP multimodal dataset. Each dataset is split into training, validation, and test sets. Notably, all datasets are multimodal, containing both text (e.g., utterances) and visual data (e.g., videos or images). However, since the model may be designed for text-based classification, only the textual information is used during training and evaluation.

For baselines, the method is compared with several Transformer-based models, including LONGFORMER, MODERNBERT, and DEEPSEEKQWEN-1.5B, all finetuned with LORA. For all models, a weight decay of 0.01, a learning rate of 0.0002, and a batch size of 16, are used with the LORA α parameter set to 8.

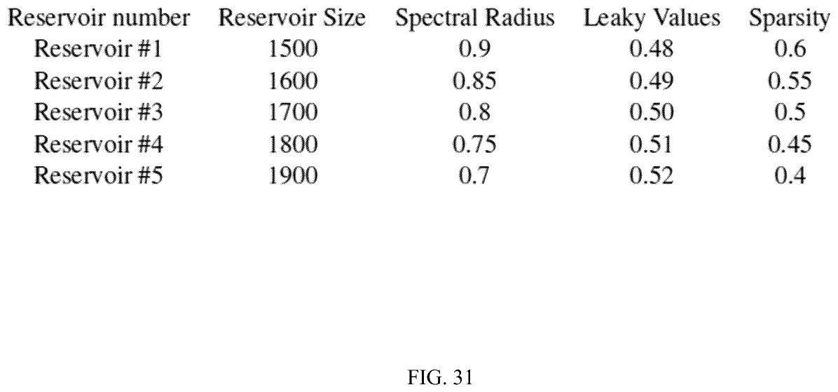

For model training, MODERNBERT acts as the Transformer backbone. The attention dropout is set to 0.1, weight decay to 0.01, and learning rate to 0.0002. For the LTM component, a total of 5 different Echo State Networks (ESNs) are employed, each with distinct initialization settings. These include varying ESN sizes from 1500 to 1900, spectral radii from 0.7 to 0.9, leaky values from 0.48 to 0.52, and sparsity levels from 0.4 to 0.6. The specific configurations for each ESN are shown in FIG. 31. Spectral radius and sparsity jointly influence the normalization of ESN states, but are found to be less critical compared to the leaky value and ESN size. Therefore, power algorithm is used to optimize their values on the validation sets.

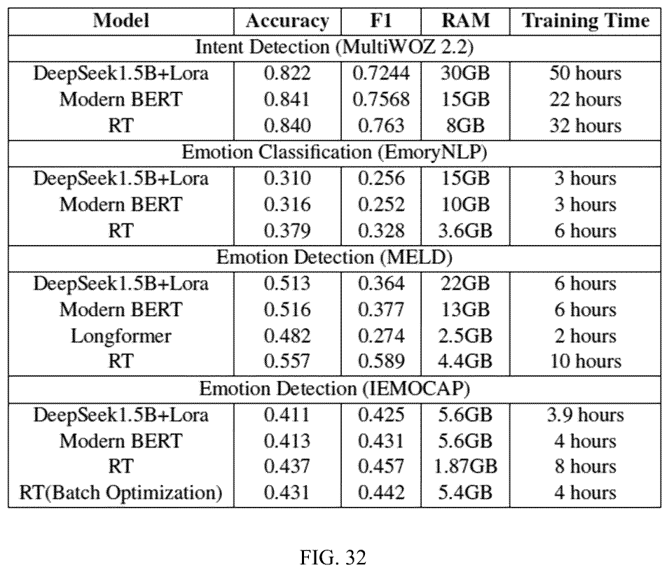

FIG. 32 illustrates a comparison of accuracy between the Echo Transformer architecture of the example embodiments of the present disclosure (hereinafter “ET”) and several baseline models. Across all three tasks, the ET model consistently achieves higher performance.

For intent detection, on MultiWOZ, ET performs on par with the MODERNBERT model. Although ET requires slightly longer training time, it consumes significantly less RAM with only about one-third of that used by MODERNBERT and DEEPSEEKQWEN-1.5B.

For emotion classification, on the EmoryNLP dataset, ET outperforms all baselines by up to +6% in prediction accuracy. Similar to the Intent Detection task, ET requires a longer training time, but again uses only about one-third of the RAM compared to MODERNBERT and DEEPSEEK-QWEN-1.5B.

For MELD dataset, ET achieves around a +4% improvement in accuracy over other baselines. For the IEMOCAP dataset, ET improves prediction accuracy by approximately +2.6% over the DEEPSEEK model and +2.4% over the MODERNBERT baseline.

Despite its longer training time, ET maintains a highly efficient memory footprint, requiring only about one-third of the RAM used by the competing models. Moreover, as described above, a batching optimization method is introduced for ET. This method reduces training time to a level comparable with other baselines, while still providing an additional +2% accuracy improvement.

The following provide a description on ablation study.

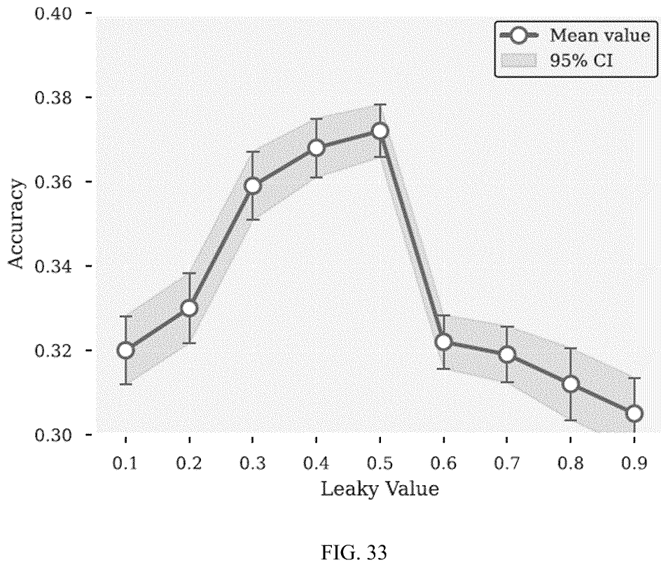

An investigation is performed on how different leaky parameter values (a) in the reservoir affect model performance. The leaky parameter controls how much past information is retained in the reservoir state. FIG. 33 illustrates leaky value effect on model performance. In particular, FIG. 33 shows the performance with different a values ranging from 0.3 to 0.7 on the EmoryNLP dataset. It is observed that α=0.4˜0.5 achieves the best performance, suggesting that moderate memory retention works better than either very short or very long memory spans.

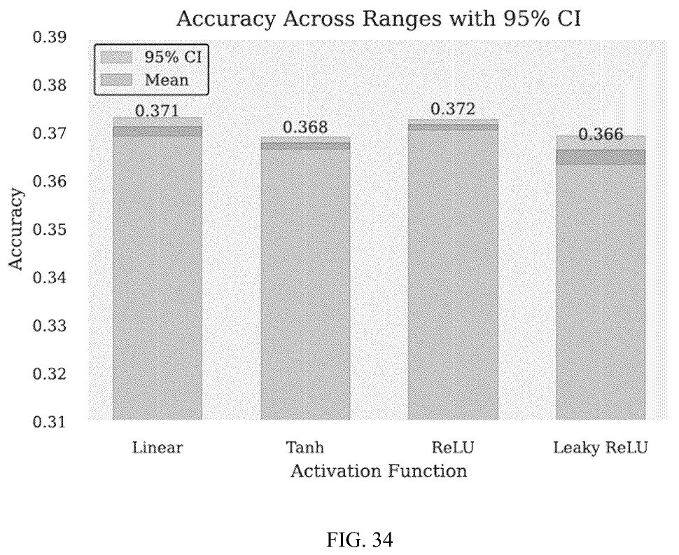

FIG. 34 illustrates activation function effect on model performance. In particular, FIG. 34 shows a comparison between the performance of different activation functions of the reservoir readout layer for experimented dataset EmoryNLP. The activation functions tested are Linear, Tanh, Relu and Leaky Relu. The Relu activation function consistently outperforms the others, but the improvement due to the activation function is not obvious enough.

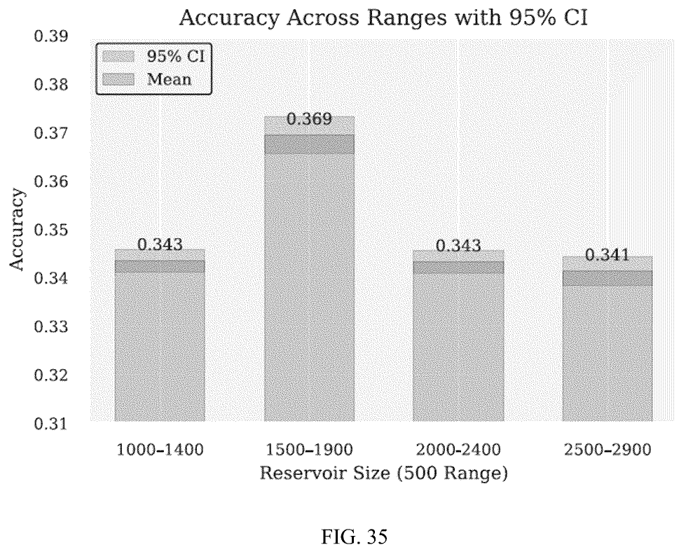

An investigation is also performed on how different reservoir sizes (N) affect model performance. The reservoir size determines the dimensionality of the network's internal state representation and its capacity to capture complex temporal dependencies. FIG. 35 illustrates reservoir effect on model performance. In particular, FIG. 35 shows the model's performance with different reservoir sizes ranging from 1000 to 3000 neurons on the EmoryNLP dataset. The results demonstrate how the reservoir's capacity influences the model's ability to process and retain information. Since there are several different reservoirs, in order to better capture how the reservoir size affects the model performance, 5 reservoirs are set to cover 500 reservoir size ranges at one time (e.g. 530 5 reservoirs are set in one reservoir net). The size for these reservoirs are 1000, 1100, 1200, 1300, 1400, in order to effectively identify which size range would achieve highest accuracy.

Several researches have been performed on efficient context handling in long-sequence modeling. A common strategy for handling long context is to modify the attention mechanism using heuristics or compress long sequences into fixed-length representations. However, these techniques often lead to information loss, limiting downstream task performance.

As input lengths grow, one naive solution is to simply scale the model, as seen in systems like LLAMA 3 and MISTRAL, which can handle sequences up to 8K tokens. Nonetheless, this approach is not scalable to arbitrarily long contexts. Instead, many methods encode prior context into fixed-size representations or modify attention to prioritize relevant information. For example, researches have demonstrate the effectiveness of such strategies on inputs up to one million tokens. Some models offload cross attention into k-NN memory structures, while others adapt models such as LLAMA for long context handling.

In terms of architectural innovation, several techniques focus on restructuring attention, including block-wise attention, ring attention, and sparse attention. Other approaches embed recurrent structures, such as RNN modules, within deep networks, or adopt statespace models that maintain fixed-size internal representations. While promising, these methods often suffer from information compression bottlenecks.

In addition, regarding the CLS token, since the Bert model was first published, CLS token was used to capture the meaning of the whole sentences and make the final classification in many sequence classification models like ModernBert, Bart, and DeepSeek. To begin with, the CLS token was inserted into the original sentence tokens (e.g. for Bert sequence classification, the input tokens are formed as [CLS token],[input sentence tokens] . . . ). As described above, a CLS token is added in the Embedding process in order to capture the meaning of whole sentence for classification. The CLS token is meaningless by itself and the embedding and positional encoding for it is settled. The CLS token was used to learn the context information step-by-step from the self-attention layer within the transformer-based model. Specifically, in each self-attention layer of the transformer-based layer 3450, the CLS token interacts with all other tokens from the input sentences, and after all transformer-based layers, the hidden states of the CLS token can be seen as the sentence-level representation of the whole sentence/sequence. After the transformer-based layer 3450, the hidden states of the CLS token are fed into a classifier which is usually a full-connected layer. In the end, the loss function will force the CLS token to learn the task-relevant all context information, just like the emotion/intent of a given sentence.

Here the CLS mechanism may be defined according to the following functions.

$$h ( l ) = M ( h ( l - 1 ) ) \qquad ( 27 )$$

h(l) may represent the hidden states of the output of the 1 layer, and may be defined according to h(l)∈R^{(n+1)×d}. In this regard, h(l)=E, which may represent an initial embedding result. Further, 1=1, . . . L, which may represent the layers in the transformer. MO may represent the encoder function of the transformer. \vec{z}(t+1) may represent transformer input obtained above.

$${h}_{t [ CLS ]} ( L ) = h ( L ) [ 0 ] ∈ {R}^{d} \qquad ( 28 )$$

h(L) [0] may represent the first hidden state of the output of the 1 layer, which corresponds to the CLS token position.

$${y}_{t} = soft max ( {W}_{classifier} {h}_{t [ CLS ]} ( L ) + {b}_{classifier} ) \qquad ( 29 )$$

W_{classifier} may represent the classification weight matrix, and may be defined according to W_{classifier}∈R^{k×d}. b_{classifier} may represent the bias term, and may be defined according to b_{classifier}∈R^{k}. K may represent the number of classes.

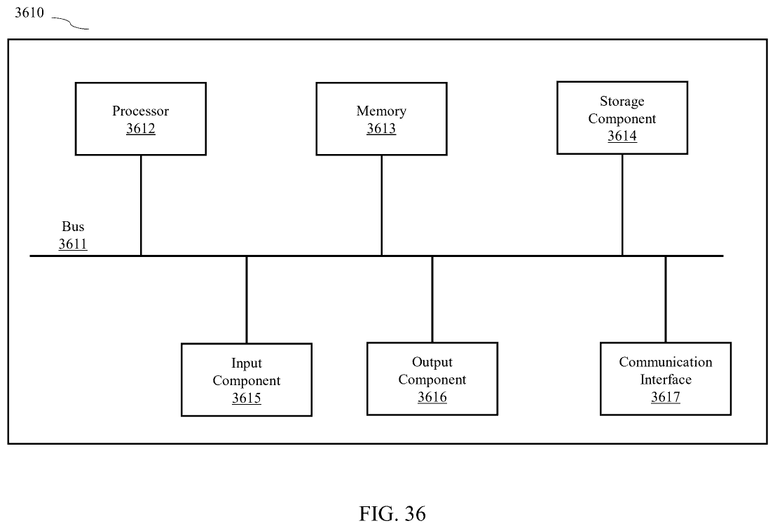

FIG. 36 illustrates a block diagram of example components in a system 3610, according to one or more example embodiments.

As illustrated in FIG. 36, the system 3610 may include at least one bus 3611, at least one processor 3612, at least one memory 3613, at least one storage component 3614, at least one input component 3615, at least one output component 3616, and at least one communication interface 3617.

It is contemplated that the system 3610 may include more or less components than illustrated in FIG. 36, without departing from the scope of the present disclosure. For instance, in some embodiments, the system 3610 may include a plurality of storage components 3614, the input component 3615 and the output component 3616 may be implemented as a transceiver component, the memory 3613 and storage component 3614 may be implemented as a memory storage, and the like.

The bus 3611 may be configured to facilitate or enable communications among the components of the system 3610. Specifically, the bus 3611 may communicatively couple the components to each other and provide a means for data transfer and flow of control signals between the components. The bus 3611 may include one or more of: an internal bus, an address bus, a data bus, a control bus, a controller area network (CAN) bus, an Ethernet bus, a peripheral component interconnect express (PCIe) bus, and any other suitable type of bus that can be implemented in the system 3610 to enable communication and coordination between the components within the system 3610 in real-time (or near real-time).

The processor 3612 may be implemented in hardware, firmware, or a combination of hardware and software, and may be configured to handle real-time (or near real-time) data processing and control of the control system 3610. The processor 3612 may include one or more of: a central processing unit (CPU), a graphics processing unit (GPU), a neural processing unit (NPU), a tensor processing unit (TPU), an accelerated processing unit (APU), a microprocessor, a microcontroller, a digital signal processor (DSP), a field-programmable gate array (FPGA), an application-specific integrated circuit (ASIC), and/or another type of processing or computing component that can be implemented in the system 3610. In some implementations, the processor 3612 may be capable of being programmed to perform one or more operations described herein. Further, the processor 3612 may include a plurality of processing units, each of which is dedicated to performing a specific operation.

The memory 3613 may include one or more mediums for storing temporary data, runtime variables, program instructions, and buffers required for the operations of the control system 3610. The memory 3613 may include one or more of: a flash memory, a read-only memory (ROM), a random-access memory (RAM), a dynamic or static storage device (e.g., a flash memory, a magnetic memory, and/or an optical memory), any other suitable type of memory that can be implemented in the system 3610 to store information and/or instructions for use by the processor 3612.

The storage component 3614 may be configured to store non-volatile data, such as firmware, configuration settings, calibration data, information, and/or software related to the operation and use of the system 3610. For example, the storage component 3614 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

According to example embodiments, the storage component 3614 may be configured to store computer-readable or computer-executable instructions for implementing one or more operations of the system 3610. The storage component 3614 may provide the stored information to the memory 3613 for the execution of the processor 3612.

The input component 3615 may include one or more input components that permit the system 3610 to receive information, such as via user input (e.g., a touch screen display, a keyboard, a keypad, a mouse, a button, a switch, and/or a microphone). The output component 3616 may include one or more output components that provide output information from the system 3610 (e.g., a display, a speaker, a navigation device, one or more light-emitting diodes (LEDs), etc.) According to example embodiments, the input component 3615 and/or the output component 3616 may be optional and may be excluded from the system 3610.

The at least one communication interface 3617 may include a transceiver-like component (e.g., a transceiver and/or a separate receiver and transmitter) that enables the system 3610 to communicate with other components (e.g., ECUs, user devices, etc.), such as via a wired connection, a wireless connection, or a combination of wired and wireless connections. For example, communication interface 3617 may include a controller area network (CAN) bus interface, an Ethernet interface, an optical interface, a coaxial interface, an infrared interface, a radio frequency (RF) interface, a universal serial bus (USB) interface, a Wi-Fi interface, a cellular network interface, or the like.

According to one or more embodiments, the communication interface 3617 may include at least one input/output (I/O) interface, at least one network interface, at least one storage interface, or the like, that enable the components 3612-3616 to communicate with other components. Further, the communication interface 3617 may include one or more application programming interfaces (APIs) that allow the system 3610 (or one or more components included therein) to communicate with one or more software applications (e.g., software application deployed in the ECUs, etc.)

Computer-executable instructions (e.g., software instructions, etc.) may be read into memory 3613 and/or storage component 3614 from another computer-readable medium or from another device (e.g., a remote server, an external storage, etc.) via, for example, the communication interface 3617. When executed, the computer-executable instructions stored in memory 3613 and/or storage component 3614 may cause the processor 3612 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

It is contemplated that features, advantages, and significances of example embodiments described hereinabove are merely a portion of the present disclosure, and are not intended to be exhaustive or to limit the scope of the present disclosure. Further descriptions of the features, components, configuration, operations, and implementations of example embodiments of the present disclosure, as well as the associated technical advantages and significances, are provided in the following.

It is understood that the specific order or hierarchy of blocks in the processes/flowcharts disclosed herein is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

Some embodiments may relate to a system, a method, and/or a computer-readable medium at any possible technical detail level of integration. Further, as described hereinabove, one or more of the above components described above may be implemented as instructions stored on a computer readable medium and executable by at least one processor (and/or may include at least one processor). The computer-readable medium may include a computer-readable non-transitory storage medium (or media) having computer-readable program instructions thereon for causing a processor (or processors) to carry out operations.

The computer readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object-oriented programming languages such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a SoC, a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or another device to cause a series of operational steps to be performed on the computer, other programmable apparatus or other device to produce a computer-implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer-readable media according to various embodiments. In this regard, each block in the flowchart or block diagrams may represent a module, segment, or portion of instructions, which comprises one or more executable instructions for implementing the specified logical function(s). The method, computer system, and computer-readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code-it being understood that software and hardware may be designed to implement the systems and/or methods based on the description herein.

What is claimed is:

1. A system comprising:
a memory storage storing computer-executable instructions; and
at least one processor communicatively coupled to the memory storage, wherein the at least one processor is configured to execute the instructions to:
obtain current input data representing a current state of a complex system;
determine a plurality of readout data based on previous input data representing a previous state of the complex system using a plurality of reservoirs;
combine the plurality of readout data to form an ensemble reservoir data; and
determine predicted output data representing a predicted state of the complex system based on the ensemble reservoir data and the current input data using a transformer.

2. The system according to claim 1, wherein the complex system comprises one or more of: traffic, weather, exchange rate, electricity, air quality, electricity transformer temperature (ETT), and in-line inspection (ILI), wherein the current state of the complex system represents a state of the complex system at a current time, and wherein the predicted state of the complex system represents a prediction of a state of the complex system at a time after the current time.

3. The system according to claim 2, wherein the previous state of the complex system represents all states of the complex system from an initial time to a time before the current time.

4. The system according to claim 1, wherein the plurality of readout data comprises a plurality of non-linear readout data, and wherein the plurality of non-linear readout data is determined based on the previous input data in combination with a self-attention mechanism using the plurality of reservoirs.

5. The system according to claim 1, wherein the plurality of readout data comprises a plurality of linear readout data, and wherein the predicted output data is determined based on the ensemble reservoir data and the current input data using the transformer and a cross-attention mechanism.

6. The system according to claim 1, wherein the plurality of reservoirs comprise echo state network (ESN) reservoirs.

7. The system according to claim 1, wherein the at least one processor is further configured to train the transformer using a loss function.

8. A method comprising:
obtaining current input data representing a current state of a complex system;
determining a plurality of readout data based on previous input data representing a previous state of the complex system using a plurality of reservoirs;
combining the plurality of readout data to form an ensemble reservoir data; and
determining predicted output data representing a predicted state of the complex system based on the ensemble reservoir data and the current input data using a transformer.

9. The method according to claim 8, wherein the complex system comprises one or more of: traffic, weather, exchange rate, electricity, air quality, electricity transformer temperature (ETT), and in-line inspection (ILI), wherein the current state of the complex system represents a state of the complex system at a current time, and wherein the predicted state of the complex system represents a prediction of a state of the complex system at a time after the current time.

10. The method according to claim 9, wherein the previous state of the complex system represents all states of the complex system from an initial time to a time before the current time.

11. The method according to claim 8, wherein the plurality of readout data comprises a plurality of non-linear readout data, and wherein the plurality of non-linear readout data is determined based on the previous input data in combination with a self-attention mechanism using the plurality of reservoirs.

12. The method according to claim 8, wherein the plurality of readout data comprises a plurality of linear readout data, and wherein the predicted output data is determined based on the ensemble reservoir data and the current input data using the transformer and a cross-attention mechanism.

13. The method according to claim 8, wherein the plurality of reservoirs comprise echo state network (ESN) reservoirs.

14. The method according to claim 8, wherein the method further comprises training the transformer using a loss function.

15. A non-transitory computer-readable recording medium having recorded thereon instructions executable by at least one processor to cause the at least one processor to perform a method comprising:
obtaining current input data representing a current state of a complex system;
determining a plurality of readout data based on previous input data representing a previous state of the complex system using a plurality of reservoirs;
combining the plurality of readout data to form an ensemble reservoir data; and
determining predicted output data representing a predicted state of the complex system based on the ensemble reservoir data and the current input data using a transformer.

16. The non-transitory computer-readable recording medium according to claim 15, wherein the complex system comprises one or more of: traffic, weather, exchange rate, electricity, air quality, electricity transformer temperature (ETT), and in-line inspection (ILI), wherein the current state of the complex system represents a state of the complex system at a current time, wherein the predicted state of the complex system represents a prediction of a state of the complex system at a time after the current time, and wherein the previous state of the complex system represents all states of the complex system from an initial time to a time before the current time.

17. The non-transitory computer-readable recording medium according to claim 15, wherein the plurality of readout data comprises a plurality of non-linear readout data, and wherein the plurality of non-linear readout data is determined based on the previous input data in combination with a self-attention mechanism using the plurality of reservoirs.

18. The non-transitory computer-readable recording medium according to claim 15, wherein the plurality of readout data comprises a plurality of linear readout data, and wherein the predicted output data is determined based on the ensemble reservoir data and the current input data using the transformer and a cross-attention mechanism.

19. The non-transitory computer-readable recording medium according to claim 15, wherein the plurality of reservoirs comprise echo state network (ESN) reservoirs.

20. The non-transitory computer-readable recording medium according to claim 15, wherein the method further comprises training the transformer using a loss function.
